(19) United States
(12) Patent Application Publication
(10) Pub. No.: US 2026/0283871 A1
(43) Pub. Date: Sep. 24, 2026

(54) AUTONOMOUS CAMERA BASED GUIDANCE SYSTEM FOR AN ELECTRIC POWERED WHEELCHAIR

(71) Applicant: ECHOTECH.AI, LLC., Indianapolis, IN (US)

(72) Inventors: ERIC MARSHALL, INDIANAPOLIS, IN (US); STEVEN SHAW, INDIANAPOLIS, IN (US)

(73) Assignee: Impersonate.ai, LLC, INDIANAPOLIS, IN (US)

(21) Appl. No.: 19/100,596

(22) PCT Filed: Feb. 13, 2024
(86) PCT No.: PCT/US2024/015506

§ 371 Date: Feb. 3, 2025

Related U.S. Application Data
(60) Provisional application No. 63/445,105, filed on Feb. 13, 2023.

(51) Int. Cl. A61G 5/04; G05D 1/243; G05D 1/622; G05D 105/22; G05D 111/10

(52) U.S. Cl. CPC A61G 5/04; G05D 1/243; G05D 1/622; A61G 2203/14; A61G 2203/22; A61G 2203/30; G05D 2105/24; G05D 2111/10

(57) ABSTRACT

An autonomous camera-based guidance system for an electric powered wheelchair. The system includes multiple cameras for providing guidance input optionally including one or more horizontally oriented cameras, and/or one or more vertically oriented cameras. The cameras may be generally directed to the front, sides, or rear of the vehicle, or in any combination thereof, and may define multiple separate and distinct fields of view which optionally overlap, and/or include portions of the vehicle. The control circuit may include neural networks, or other decision-making models configured to determine a path and a corresponding series of commands for the vehicle drive system that will result in the vehicle moving along the path in a safe and comfortable manner.

### BACKGROUND

The present disclosure relates generally to systems for providing autonomous control of a vehicle based on image data received from multiple cameras and processed by a decision-making algorithm in real time. As the number of autonomous vehicles has increased in recent years, so too have the demands and the complexity of autonomous control systems. For example, many autonomous vehicle navigation systems rely on extensive pre-mapping of an environment, or special navigational aids such as position beacons, GPS or other location finding services. In other instances, autonomous guidance systems require very precise placement of active or passive sensor arrays specifically calibrated to a particular vehicle, and to a particular location on the vehicle. Changes to the position, angle, or other configuration of these sensor arrays generally means the control logic must be recalibrated because the point of view of the sensor is now different. Also, these systems often rely on specific object classification and therefore often have difficulty navigating through a new environment with different types of objects which may not be recognizable to the sensors.

In the case of wheelchairs specifically, operating an electric wheelchair involves additional challenges. Controlling an electric wheelchair involves constant and precise input from the user or an assisting caregiver, which can be particularly demanding for those with severe mobility limitations. The Latched Drive feature in electric wheelchairs enables users with restricted mobility to control electric wheelchairs using Adaptive Control Interfaces like sip-and-puff, head, or chin controls, and the like. This technology allows the user to direct the chair based on initial user command, thereby eliminating the need for continuous manual input. However, this can lead to significant challenges for the user, especially when navigating tight spaces or rapidly changing situations where the user may be incapable of reacting quickly enough. The user may not discern impending danger quickly enough, or they may not be physically capable of reacting fast enough to redirect the wheelchair.

### SUMMARY

Disclosed is an autonomous guidance system for a vehicle, such as a powered wheelchair, that relies on image data received in real time from an onboard camera system in order to determine a safe path for the vehicle. Vehicles of the present disclosure optionally include a drive system, a sensor assembly, and a control circuit. The control circuit is optionally responsive to one or more sensors of the sensor assembly, and the drive system is responsive to the control circuit. The control circuit includes processors, memory, control logic, and other aspects configured to accept input from the sensor assembly, and optionally to determine a path for the vehicle that avoids hazards and obstacles in its path. In another aspect, the control circuit may be configured to be responsive to environmental input such as traffic signals, pavement markings, and people, vehicles, or other objects moving nearby.

In another aspect, the sensors assembly includes one or more cameras. The cameras of the disclosed camera system may include one or more horizontally oriented cameras, and/or one or more vertically oriented cameras. The cameras may be generally directed forward of the vehicle, to the rear of the vehicle, to the sides of the vehicle, or in any direction that may be useful in providing guidance input for the vehicle. The cameras may be oriented substantially parallel with the central axis of the vehicle, aligned away from or toward the central axis. Cameras of the present disclosure optionally mounted at the front of the vehicle, at the back of the vehicle, at the sides of the vehicle, or in any other suitable location. In another example, the cameras are optionally mounted on arms or outriggers that suspend the camera above or to the left or right of the vehicle.

In another aspect, cameras of the present disclosure optionally define multiple separate and distinct fields of view, or in the alternative, multiple fields of view where at least a portion of one field-of-view for one camera overlaps at least a portion of another field-of-view for a second camera.

In another aspect, the disclosed vehicle may include one or more cameras that define a field-of-view that includes a portion of the vehicle. For example, a vertically oriented camera the mounted above the vehicle and directed such a manner as to define a field-of-view that includes some of the vehicle, all of the vehicle, or optionally none of the vehicle. The control circuit may use imagery that includes the vehicle in determining the location of obstacles, and a path around them. In another aspect, the camera system optionally includes multiple horizontal and vertically oriented cameras thus providing the control circuit with multiple image feeds that may directed forward, backward, down, laterally left or right, or any combination thereof. In another aspect, any of the cameras may be mounted and adjustable mounts allowing the camera to be repositioned while the vehicle is in operation.

In another aspect, vehicle of the present disclosure includes one or more drive elements such as wheels, tracks, or other ground contacting elements, and/or propellers, screws, and the like. The vehicle optionally includes a drive system having an electric motor generator and a battery assembly electrically connected to the electric motor generator for providing power to the electric motor generator when the electric motor generator is operating in a driving mode to provide power to drive the vehicle, or optionally for receiving power when the electric motor generator is operating in the generator mode. In another aspect, vehicles of the present disclosure may include an internal combustion engine.

Also disclosed is a pathfinding, guidance, and autonomous control system for a vehicle of the present disclosure such as a powered wheelchair. The autonomous control system includes a camera system of the present disclosure operable to obtain visual cues from the surrounding environment. The disclosed control system is configured to process image data from the cameras along with other inputs in real time as the wheelchair is moving, to provide a safe and comfortable experience for the person in the chair, and for others in the area.

The wheelchair may provide multiple operating modes including, but not limited to, an “autonomous” mode where the vehicle controls all operations, “a semi-autonomous” mode where the vehicle controls most operations with some input from an operator, a “shadow” or safety mode where the operator provides most if not all control input and the vehicle intervenes when necessary to keep the operator safe, and a “full manual” mode where the autonomous features are disabled and the wheelchair is controlled only by the operator.

In one aspect, the autonomous wheelchair is another example of a vehicle of the present disclosure and thus it includes a drive system, a sensor assembly, and a control circuit. The control circuit is responsive to one or more sensors of the sensor assembly, and the drive system is responsive to the control circuit. The control circuit includes cameras, processors, memory, control logic, etc. The autonomous wheelchair optionally also includes decision-making models such as a Convolutional Neural Network (CNN), a Transformer Model, Large Language Model (LLM), or any other suitable artificial intelligence algorithm configured to accept input from the cameras and other sensors, the wheelchair's built in drive system, and/or the operator, in order to determine the best path for the powered wheelchair that avoids hazards and obstacles in its path.

Further forms, objects, features, aspects, benefits, advantages, and examples of the present invention will become apparent from a detailed description and drawings provided herewith.

### BRIEF DESCRIPTION OF THE DRAWINGS

FIG. 1 is a component diagram illustrating one example of the basic components of a vehicle of the present disclosure.

FIG. 2 is a component diagram illustrating another example of components that may be included in a vehicle of the present disclosure.

FIG. 3 is a schematic diagram illustrating orientation will and directional components of cameras of the present disclosure.

FIG. 4 is a schematic diagram illustrating aspects of horizontally oriented cameras of the present disclosure.

FIG. 5 is a schematic diagram illustrating mounting locations for cameras of the present disclosure.

FIG. 6 is a schematic diagram illustrating another example of horizontally oriented cameras of the present disclosure.

FIG. 7 is a diagram illustrating one example of a field-of-view obtained by a horizontally oriented camera of the present disclosure.

FIG. 8 is a diagram illustrating another example of multiple overlapping fields of view obtained by multiple horizontally oriented cameras of the present disclosure.

FIG. 9 is a diagram illustrating Yet another example of multiple separate and distinct fields of view obtained by multiple horizontally oriented cameras of the present disclosure.

FIG. 10 is a schematic diagram illustrating an example of vertically oriented cameras of the present disclosure.

FIG. 11 is a diagram illustrating one example of a field-of-view obtained by a vertically oriented camera of the present disclosure.

FIG. 12 is a diagram illustrating an example of multiple fields of view obtained by multiple vertically oriented cameras of the present disclosure.

FIG. 13 is a diagram illustrating Yet another example of a field view obtained by a vertically oriented camera of the present disclosure.

FIG. 14 is a perspective view of one example of a basic vehicle of the present disclosure having multiple horizontal and vertically oriented cameras on fixed and repositionable mounts.

FIG. 15 is a schematic diagram illustrating a one wheeled vehicle of the present disclosure.

FIG. 16 is a schematic diagram illustrating a two wheeled vehicle of the present disclosure.

FIG. 17 is a schematic diagram illustrating a three wheeled vehicle of the present disclosure.

FIG. 18 is a schematic diagram illustrating a four wheeled vehicle of the present disclosure.

FIG. 19 is a schematic diagram illustrating a six wheeled vehicle of the present disclosure.

FIG. 20 is a schematic diagram illustrating a vehicle of the present disclosure having a single continuous belt or track.

FIG. 21 is a schematic diagram illustrating a vehicle of the present disclosure having two continuous belts or tracks.

FIG. 22 is a schematic diagram illustrating a waterborne vehicle of the present disclosure.

FIG. 23 is a schematic diagram illustrating an airborne vehicle of the present disclosure.

FIG. 24 is a front perspective view of another example of a vehicle of the present disclosure.

FIG. 25 is a front view of the vehicle of FIG. 24.

FIG. 26 is another different perspective view of the vehicle of FIG. 24.

FIG. 27 is a bottom view of the vehicle of FIG. 24.

FIG. 28 is a right side view of the vehicle of FIG. 24.

FIG. 29 is a component view illustrating aspects of the vehicle of FIG. 24.

FIG. 30 is a diagram illustrating one example of a field-of-view of a camera mounted to the vehicle of FIG. 24.

FIG. 31 is a diagram illustrating another example of a field-of-view of a camera mounted to the vehicle of FIG. 24.

FIG. 32 is a diagram illustrating another example of a field-of-view of a camera mounted to the vehicle of FIG. 24.

FIG. 33 is a diagram illustrating another example of a field-of-view of a camera mounted to the vehicle of FIG. 24.

FIG. 34 is a diagram illustrating another example of a field-of-view of a camera mounted to the vehicle of FIG. 24.

### DETAILED DESCRIPTION

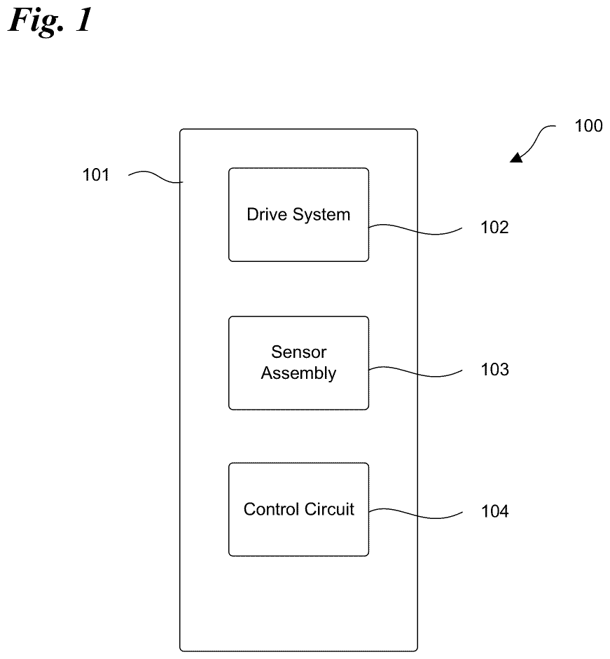

Disclosed is a camera system and autonomous pathfinding and control system for a vehicle, examples of which are illustrated in the accompanying drawings and described in detail below. In one example shown in FIG. 1 at 100, a vehicle 101 of the present disclosure includes a drive system 102 for engaging the surrounding nearby ground, water, air, or other aspect of the environment and for applying motive force thereto to cause the vehicle 101 to move.

The disclosed vehicle may include a sensor assembly 103 having one or more sensors configured to detect changes in one or more sense parameters related to the vehicle 101 or the environment around it. These sense parameters include visible light, heat, pressure, acceleration, and the like. The vehicle of the present disclosure optionally includes a control circuit 104 operable to accept input from the sensor assembly 103, or other inputs, and to provide control signals, commands, or other control output to drive system 102. The control circuit 104 may also receive input from other computers remote from the vehicle that are in communication with the vehicle via one or more communication links. Drive system 102, sensor assembly 103, and control circuit 104 may be in communication with one another, such as by being electrically connected together with circuits, wires, or cables, or by a wired or wireless communication links.

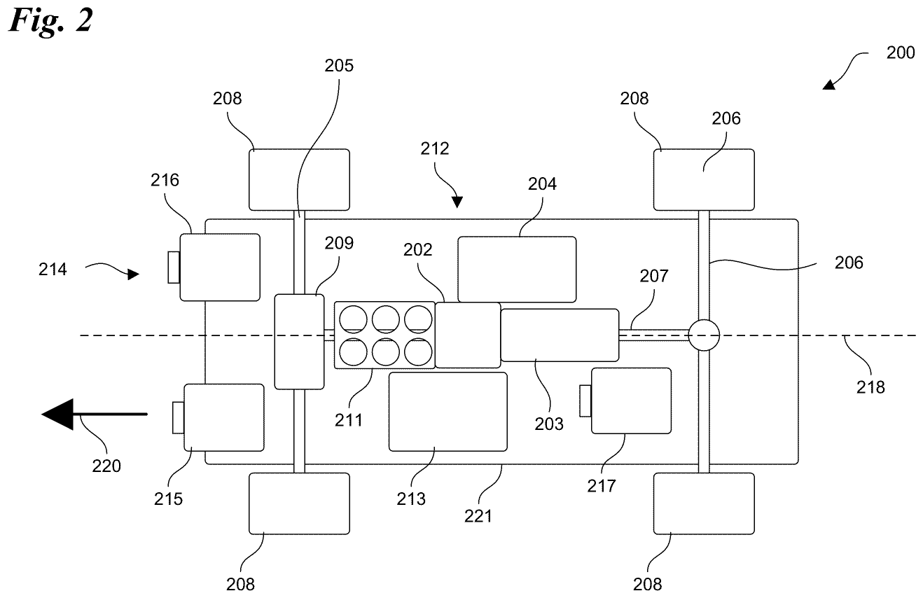

Another example of a vehicle 200 of the present disclosure is shown in FIG. 2. The vehicle 200 optionally includes a drive system at 212, a control circuit 213, and a sensor assembly at 214. The sensor assembly 214 optionally includes one or more sensors 215-217 which may include one or more cameras operable to obtain video or still images of the surrounding environment for processing by the control circuit 213. Other aspects of the sensor assembly optionally include, but are not limited to, Light Detection and Ranging (LIDAR) devices which may be useful for direct distance measurements and for determining three-dimensional shapes of objects in the area around the vehicle, determining how fast nearby objects are moving, and in what direction, to name a few nonlimiting examples. LIDAR systems may also be useful for determining a specific location of the vehicle relative to other objects. In another aspect, vehicle of the present disclosure is optionally configured to operate without LIDAR and to rely (optionally exclusively) on two-dimensional imagery provided by the horizontally and/or vertically oriented cameras of the present disclosure.

In another aspect, the sensor assembly may include location finding systems that may rely on radio signals provided by satellites, or by nearby radio transmitters such as might be used in Wi-Fi networks, stationary beacons, or a cellular communication network, to name a few nonlimiting examples. In another aspect, the sensor assembly may include sensors for detecting the vehicles attitude relative to gravity. For example, the sensor assembly may be configured to determine when the is upside down, about to tip over, and the like. The vehicle 200 may optionally include ultrasonic perimeter detection emitters and transducers configured to emit and detect reflected ultrasonic high-frequency sound waves for determining whether a relative distance to nearby objects. Other sensors that may be included are acceleration, speed, ambient light, temperature, humidity, sound, and others.

As shown in FIG. 2, sensors 215 and 216 may include one or more front facing cameras. These front facing cameras may separately define multiple independent fields of view, or in the alternative, the fields of You may overlap one another. In another aspect, multiple front-facing cameras of sensor assembly 214 may define separate fields-of-view that is then optionally combined using software modules executed by one or more processors or other aspects of control circuit 213 to provide a seamless view forward of the vehicle 201. In this example, the “forward direction” is indicated at 220.

In another aspect, forward facing cameras of sensor assembly 214 may define fields of view which are substantially parallel to a central axis 218 of the vehicle 201, or may be angled away from axis 218 and may thus be directed obliquely with respect to forward movement of the vehicle. In another aspect, sensors of sensor assembly 214 may define a field-of-view that includes a portion of the vehicle 201 thus providing an opportunity for control circuit 213 to be “self-aware” as to the location of portions of the vehicle with respect to the surrounding environment. The control circuit 213 may be configured to process input from the sensor assembly 214 and two use the portion of the vehicle that is visible within the field-of-view for reference when making path calculations and providing control output.

In another aspect, the vehicle 201 optionally includes a drive system 212. The drive system 212 optionally includes an internal combustion engine 211, and an optional electric motor generator 202 electrically connected to a battery assembly 204. The battery 204 may be operable as a power source for the vehicle drive system, or as a power sink operable to accept and retain power obtained from operation of the vehicle. In one example, the control circuit 213 my control the electric motor generator 202 in a driving mode to apply an output torque to wheels 208 or other elements configured to engage the environment to provide motion. In another aspect, the control circuit 213 may control the motor generator in a generator mode to harvest and store power such as by regenerative braking when the vehicle is coasting downhill or to a stop.

A transmission 203 may be coupled to the motor 202 and/or the internal combustion engine 211 in any suitable fashion to allow transfer of power to one or more wheels 208. In this example, wheels 208 provide contact with supporting surface such as the ground, and thus may be operable as ground engaging elements configured to transfer driving torque from the internal combustion engine 211 and/or the motor generator 202 to the support surface to move the vehicle. The drive system 212 optionally includes a steering mechanism 209 operable to cause the vehicle to change direction under the control of control circuit 213. Any suitable steering operation may be employed such as rotation of one or more wheels 208, changing the speed of left side wheels versus right side wheels, and the like. The transmission 203 may, for example, be coupled to wheels 208 via a driveshaft assembly 207 coupled to a rear shaft assembly 206 and/or a front shaft assembly 205. In this way, power may be transferred from the transmission to one or more of the wheels.

In one aspect, the vehicle 201 may be a 2-wheel drive vehicle driven by any two of wheels 208 (e.g., the front two, the rear two, a front left and a right rear, or front right and the left rear, to name a few nonlimiting examples). The sensor assembly 214, engine 211, transmission 203, and other aspects of the vehicle 200 may be coupled to a frame 221 or other support structure. The frame 221 optionally provides support for mounting the components of the vehicle.

A control circuit of the present disclosure is optionally configured to accept input from one or more cameras, or other sensors present in the sensor assembly. Control circuit may include control logic defining one or more rules, or other decision-making algorithms, configured to determine a response based on input obtained from the cameras and/or other sensors. These responses include, but are not limited to, determining when there are obstacles in the path of travel, determining a path around obstacles, and/or detecting environmental cues. These environmental cues include, but are not limited to, streetlights, pedestrian signals, the movement of nearby objects, people, or animals, the presence of sidewalks, lines on the pavement, road signs, polls, or buildings, including doors, windows, or other entrances. The control circuit is operable to control the steering mechanism 209, and other aspects of the drive system 212, in order to direct the vehicle along the chosen path. In another aspect, the control circuit may include route finding capabilities such as determining paths through or around various aspects of the environment to reach a destination that may or may not be presently visible to the cameras mounted to the vehicle. For example, control circuit 213 may use location finding services such as GPS, to determine a route, while control circuit 213 may also except input from cameras or other sensors in order to navigate the route chosen.

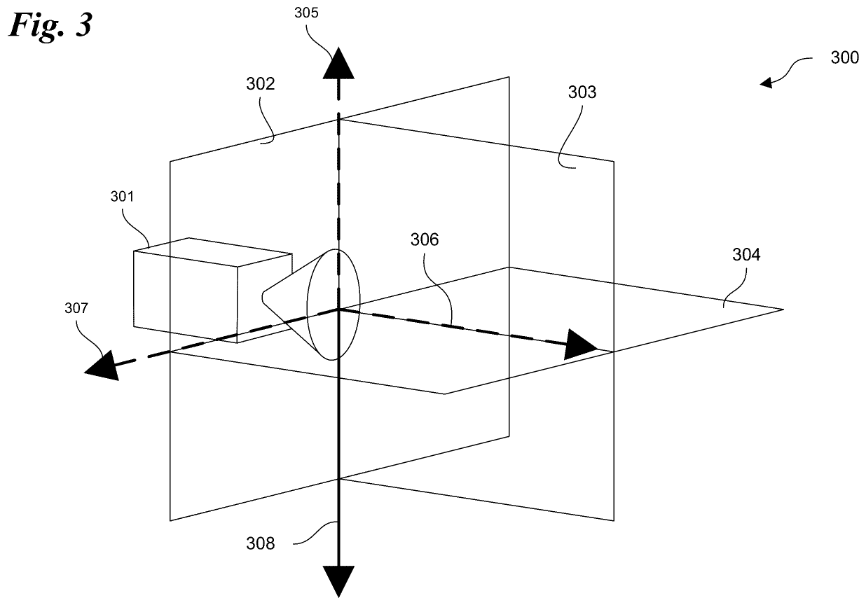

Vehicles of the present disclosure may include one or more cameras pointed horizontally, vertically, or in any suitable combination thereof. Examples of different camera configurations are illustrated throughout. Illustrated in FIG. 3 at 300 is one example of a camera of the present disclosure along with orientation aspects. Camera 301 defines a field of view 302 representing a two-dimensional plane upon which images are captured by Charged Coupled Devices (CCDs) or other sensors of the camera that are light-sensitive.

Directional vectors referred to in the present disclosure include an “up/down” Y-axis vector 305 on a vertical plane 303, a “forward/backward” X-axis vector 306, and a “left/right” Z-axis vector 307. In general, the X-axis and Z-axis vectors are orthogonal to one another on a horizontal plane 304. The Y-axis vector 305 and the Z-axis vector 307 are also generally orthogonal to one another on the field of view plane 302. The Y-axis and X-axis vectors are generally orthogonal to one another on the vertical plain 303. Thus, the horizontal, vertical, and field of view planes are orthogonal to one another.

A gravity vector 308 is used throughout the present disclosure to describe the orientation of cameras or other objects with respect to gravity the field-of-view (i.e., the earth). Thus, for example, when the camera 301 is level with the horizon, the gravity vector 308 is generally orthogonal to the X and Z axes, and parallel to the Y-axis irrespective of the rotational position of the camera along the Y-axis.

In another aspect, the X, Y, and Z axes in FIG. 3 may also be thought of in terms of rotational positioning. Rotating on the Z-axis “pitches” the camera toward the upper or lower sides of the field of view causing the image captured by the field of view to shift accordingly. Rotation on the X-axis “rolls” the camera causing the image in the field of view to shift by rotating clockwise or counter clockwise. Rotation on the Y-axis causes the camera to “yaw” causing the image captured by the field of view to shift laterally across the field of view.

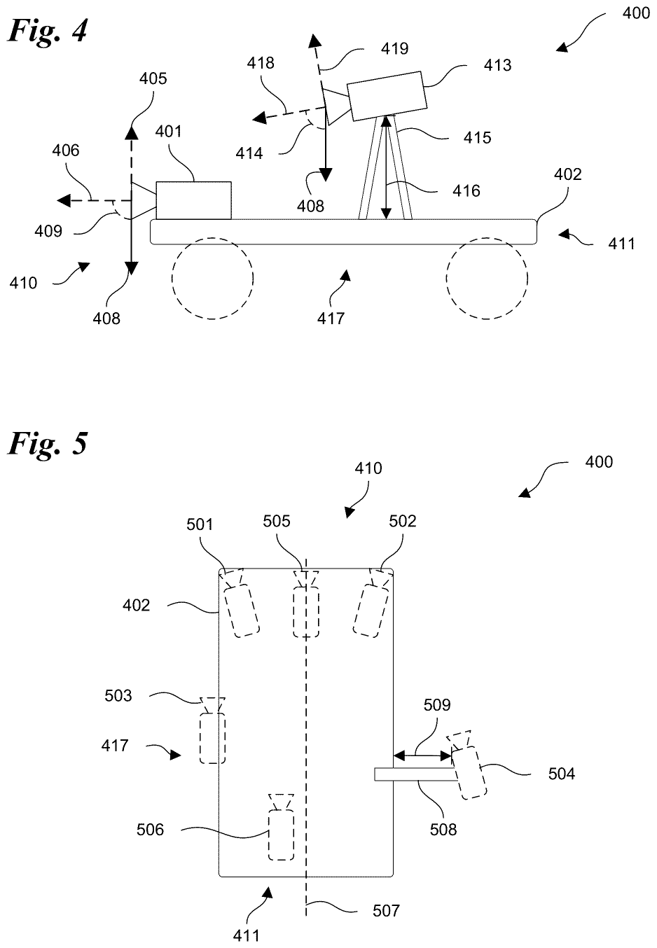

FIGS. 4 and 5 illustrate aspects of a vehicle 400 of the present disclosure that has one or more horizontally oriented cameras. A frame or other support structure 402 is optionally included for supporting the cameras, drive system, wheels, and the like. A camera 401 defines a Y-axis 405, and an X-axis 406 (and the Z-axis extends directly into and out of the page in this example). In a horizontal configuration, Y-axis 405 is generally parallel to gravity vector 408, and generally perpendicular to X-axis 406. As defined herein elsewhere, cameras with a “horizontal” orientation may be tilted as much as 45 degrees away from being exactly perpendicular with respect to the gravity vector. Thus, angle 409 between the X-axis, or forward plane, of horizontally oriented camera 401, may vary from 45 to 135 degrees relative to gravity 408. Camera 401 is optionally mounted adjacent to the front 410 of vehicle 402. In another aspect, camera 401 is optionally pointed away from the rear of the vehicle 411, thus making it a front facing camera.

In another example, a horizontally oriented camera 413 may be mounted away from the vehicle 402 such as on a mount 415. Mount 415 optionally offsets the camera 413 by a distance 416 above the vehicle 402. In another example, the camera 413 may be mounted a distance below the vehicle with the camera mounted under the frame 402. In another example, the camera 401 or 413 may be mounted within the frame 402.

In another aspect the camera 413 may be optionally horizontally oriented and front facing and may define a forward plane with an X-axis 418 oriented at 90 degrees with respect to gravity 408. In another configuration shown in FIG. 4, camera 413 is optionally horizontally oriented and deflected downward with an angle 414 that is less than 90 degrees with respect to gravity 408. In this example, camera 413 is optionally mounted adjacent a middle region 417 of the vehicle.

In another aspect, one or more cameras 401, 413, and others, may be mounted in any suitable location on the vehicle. For example, cameras may be mounted adjacent to the front of the vehicle at 501 or 502, or two separate cameras may each be mounted in both of these locations to provide stereoscopic imagery as input to the control circuit of the present disclosure. In another aspect, cameras may be mounted at 505 on or adjacent to a central axis of the vehicle 507. In another example, cameras may be mounted adjacent to a lateral edge of the vehicle 402 at 503 or 504, and optionally near the middle region of the vehicle 417. In another example, one or more front-facing cameras may be located at 506 adjacent the rear of the vehicle. In these examples, the cameras are shown facing forward, however, no limitation on the direction of orientation is imposed. Any of the one or more cameras may be horizontally oriented and/or pointed in any suitable direction with respect to the vehicle.

In another aspect shown in FIGS. 4 and 5, cameras of the present disclosure may be oriented laterally in any suitable configuration. For example, cameras may be oriented outward away from the central axis 507 of the vehicle such in the example shown at locations 501 and 502. In another aspect, the cameras may be oriented laterally inward toward the central axis of the vehicle as in the example shown at location 504. The cameras may be mounted on a mount 508 extending outwardly away from the sides of the frame 402 and the central axis of the vehicle 507. In this way, a camera of the present disclosure may be laterally offset away from the vehicle by distance 509 away from the vehicle. In another aspect, the mount 508 may be a separate assembly distinct from frame 402 and coupled to it, or it may optionally be an integral portion of frame 402.

In another aspect shown in FIGS. 4 and 5, multiple cameras may be configured and arranged on a vehicle of the present disclosure such that some or all of the cameras have different fields of view and are generally insensitive to their exact position relative to the rest of the vehicle. A vehicle may include cameras pointed in different directions relative to the vehicle 400, such as at locations 505 and 504. In another example, a vehicle may include cameras positioned at differing heights above the rest of the vehicle, like in the case of camera 401 and 413. A vehicle may include multiple cameras with different lateral offsets relative to the central axis 507 of the vehicle, such as at locations 506 and 502.

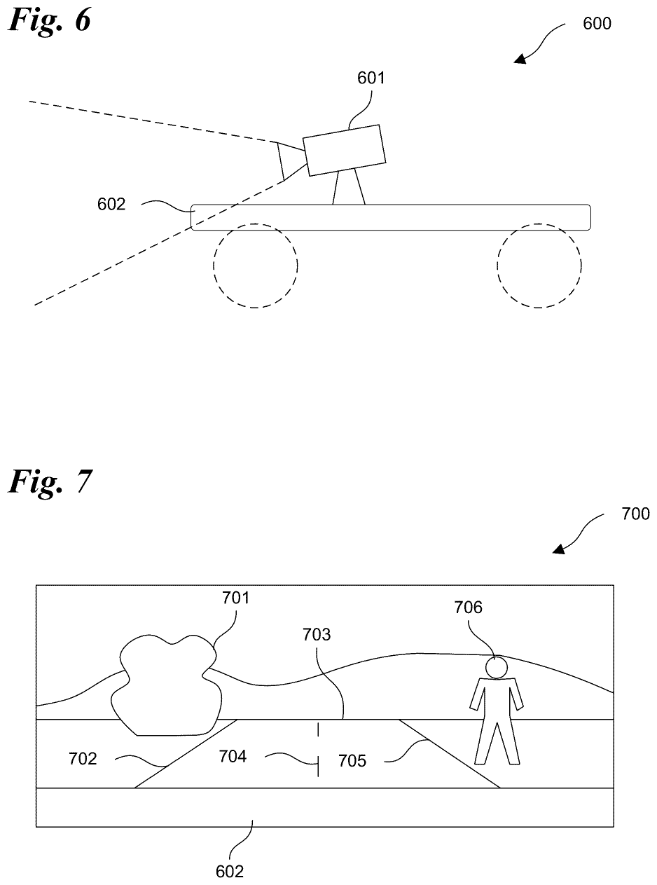

In another aspect, the fields of view of one or more of the horizontally oriented cameras optionally include a portion of the vehicle. FIG. 6 illustrates a vehicle 600 of the present disclosure that includes a camera 601 horizontally oriented and configured to capture a front portion of the vehicle 602. A possible resulting field of view of camera 601 is illustrated at 700 in FIG. 7. The portion of the vehicle 602 captured by the camera 601 appears in the lower portion of the field of view 700. Other objects that may be visible in the field of view at 700 include obstacles 701 such as bushes, buildings, poles and the like, boundary markings such as curbs, lines, and the like at 702 and 705, path markings 704 delineating lanes, or portions of roads or paths, and/or nearby people or animals 706. Including a portion of the vehicle in the field of view captured by the cameras of the disclosed camera system may be useful for the algorithms executed by a control circuit of the present disclosure in determining where other nearby objects are in relation to the vehicle, whether they are stationary or moving, and optionally how best to avoid them. The portion of the vehicle captured by a camera may include a front, side, rear, or other portion, or any combination thereof, including corners, sides, or edges.

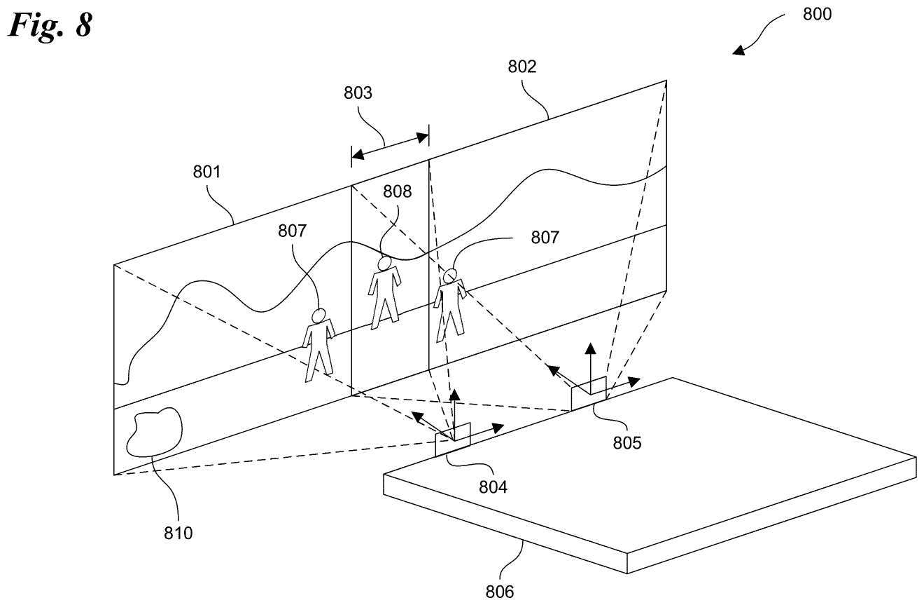

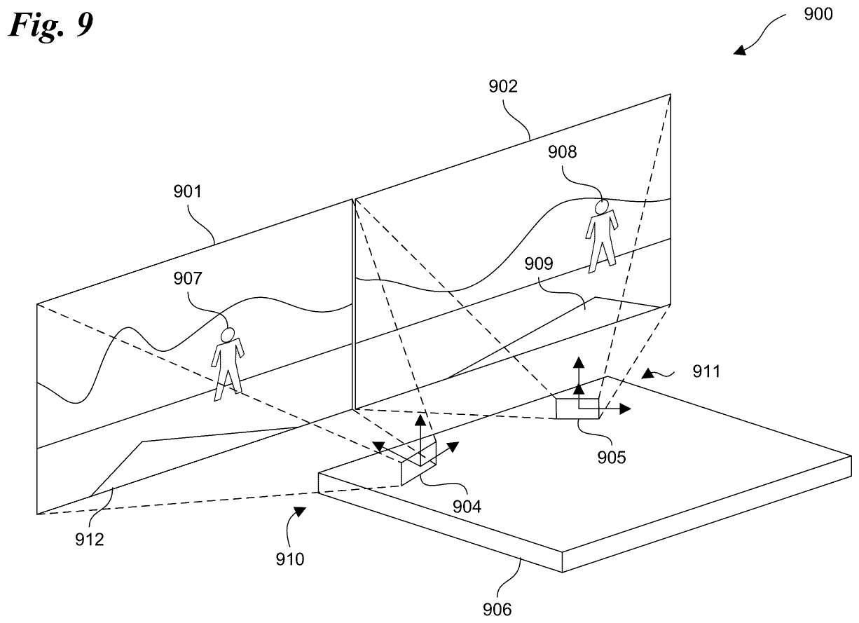

Multiple cameras for a vehicle of the present disclosure may be arranged and configured such that their fields of view overlap, as shown in FIG. 8, or are separate and distinct as shown in FIG. 9. At 800, two separate cameras 804 and 805 are optionally mounted adjacent one another on a vehicle 806. Camera 804 defines a field of view 801, and camera 805 defines a field of view 802. In this overlapping example, an overlap portion 803 is common to both fields of view. In this example, an object 807 appears toward the right side of the left field of view 801 and toward the left side of the right field of view 802. In another example, an object 808 appears in the overlapping portion 803 of the two fields of view. In another example, an object 810 is an example of an object that appears in one field of view 801, but not in the other field of view 802.

In FIG. 9, at 900, two separate cameras 904 and 905 are optionally mounted adjacent one another on a vehicle 906. Camera 904 defines a field of view 901, and camera 905 defines a field of view 902. In this example, the fields of view 901 and 902 are optionally separate and distinct, and do not overlap one another. An object 907 appears toward the middle of the left field of view 901 and not in the right field of view 902. In another example, an object 908 appears in the right field of view 902, but not in the left field of view 901. In another aspect, the camera 904 is optionally arranged and configured with respect to the vehicle 906 so that a corner portion 910 appears in the field of view 901 in the lower right corner of the field of view at 912. The camera 905 is optionally arranged and configured with respect to the vehicle 906 so that a different corner portion 911 of the vehicle 906 appears in the field of view 902 in the lower left corner of the resulting image at 909.

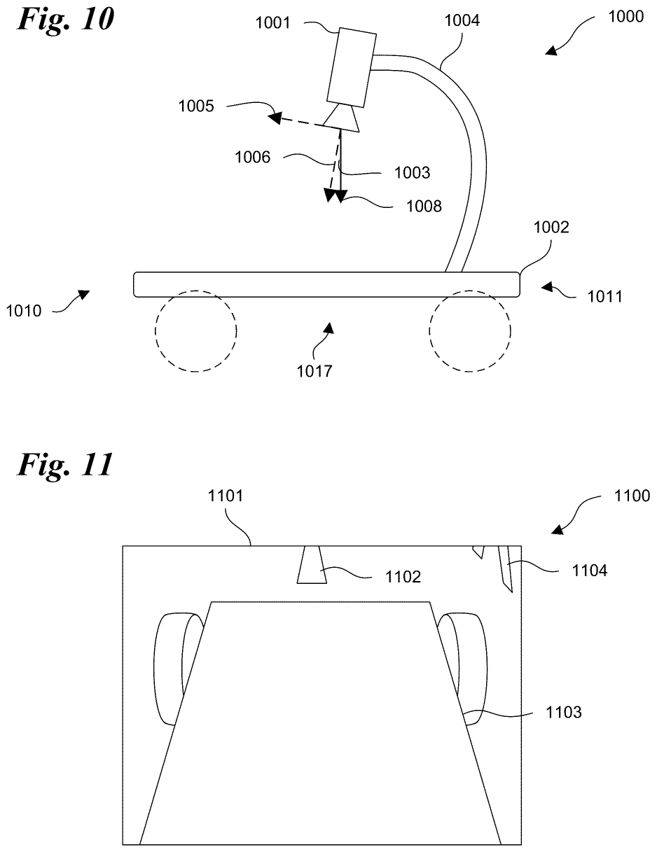

Illustrated in FIGS. 10 and 11 is a vehicle 1000 that has a vertically oriented camera. Other sensors and cameras are not shown in FIG. 10 for clarity, but no limitation is thus implied. Any suitable arrangement of one or more horizontally and/or vertically oriented cameras may be used.

The vehicle has a frame or other support structure 1002 and a vertically oriented camera 1001. In this example, the angle 1003 between gravity 1008 and the X-axis vector 1006 is close to zero—which means that camera 1001 is generally pointed vertically and toward the vehicle frame 1002. A vertical camera mount 1004 is configured to retain the camera above the frame 1002 such that some or all of the vehicle frame is visible to the camera 1001.

An example of a field of view that may be defined by a camera like camera 1001 is illustrated at 1100 in FIG. 11. In this example, a vertically oriented camera defines a field of view 1101 wherein a portion of vehicle 1103 is visible. Other aspects of the surrounding environment that may be visible as well in the field of view 1101 include lines, stripes, signage, or other markings 1102 on the ground, as well as people, animals, signposts, curbs, holes, obstacles, or other objects 1104. These may be used as input by the control circuit of the present disclosure along with the visible portion of the vehicle 1103 to make calculations in determining how to drive towards or away from the visible objects.

In another aspect, vertically oriented cameras of the present disclosure may be positioned in any suitable location of the vehicle, examples of which are illustrated in FIG. 5. As discussed herein with respect to horizontally oriented cameras, and with cameras in general, vertically oriented cameras may be front facing, rear facing, angled toward or away from the vehicle, mounted on a central axis of the vehicle, offset from the vehicle on a mount that extends away from the vehicle, or arranged and configured in any other suitable configuration.

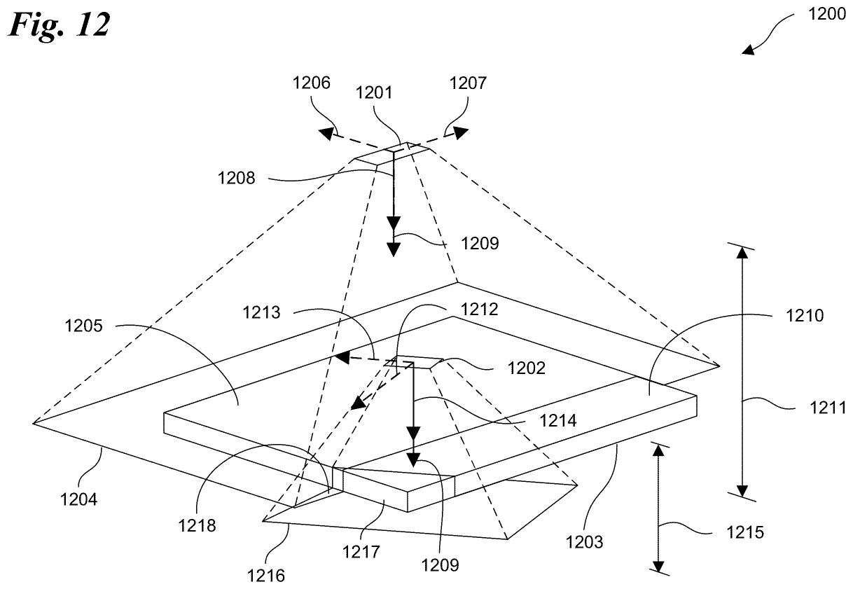

In another aspect illustrated in FIG. 12, multiple vertically oriented cameras of the present disclosure may be positioned at different heights and in different locations with respect to a vehicle thus providing the disclosed control circuit with multiple vertically oriented inputs from different points of view. Cameras 1201 and 1202 are optionally mounted above a vehicle 1203 and may be vertically oriented facing downward as shown.

Camera 1201 optionally defines a Y-axis vector 1206 which generally points up and down across the camera's field of view, a Z-axis vector 1207 which generally points left and right across the field of view, and an X-axis vector 1208 that generally points directly into or out of the field of view of the camera. The gravity vector is illustrated at 1209. In this example, camera 1201 is vertically oriented such that the angle of incidence between the X-axis vector 1208, and the gravity vector 1209 is substantially 0 degrees. Thus, the camera 1201 is mounted substantially perpendicular to the vehicle 1203 at a predetermined distance 1211 away from the vehicle. In another aspect, the distance 1211 may be adjustable or otherwise reconfigurable. In this configuration, the camera 1201 defines a field-of-view 1204 that includes a portion of the vehicle 1205 that is within the field-of-view, and another portion 1210 that is outside the field-of-view 1204.

Camera 1202 optionally defines a different Y-axis vector 1212, a different Z-axis vector 1213, and a different X-axis vector 1214. In this example, camera 1202 is vertically oriented such that the angle of incidence between the X-axis vector 1214, and the gravity vector 1209 is substantially 0 degrees. Thus, the camera 1202 is mounted substantially perpendicular to the vehicle 1203 at a predetermined distance 1215 away from the vehicle, a distance which is optionally adjustable. In this configuration, the camera 1202 defines a field-of-view 1216 that includes a portion of the vehicle 1217 that is within the field-of-view 1216, and another portion 1210 that is outside the field-of-view 1216.

In another aspect, the field-of-view of the one or more vertically oriented cameras 1201 and 1202 may be separate and distinct, like what is illustrated in FIG. 9, or they may overlap similar to the example illustrated in FIG. 8. In the example of FIG. 12, the fields of view 1204 and 1216 overlap in a region 1218 that is viewable by both cameras 1201 and 1202.

In another aspect, the vertical offset of each camera may be the same, or different. For example, the distance 1211 and 1215 may be substantially equal, or may be variable in height. The vehicle may automatically adjust the heights 1211 and 1215 during operation in response to input received by the control circuit and according to output commands or signals provided there from.

In another aspect, the field-of-view 1204, and 1216 may extend beyond the perimeter of the vehicle, thus providing visual input regarding where the vehicle is relative to nearby objects or environmental features. In another aspect, illustrated in FIG. 12, cameras 1201, and 1202 are pointed in different directions. That is to say, at least one of the corresponding X, Y, and Z vectors for both cameras are not parallel. In another aspect, the vertically oriented cameras of the present disclosure may be centered over the vehicle, or offset to one side or the other, or front to back, thus putting the cameras in differing locations. The cameras in FIG. 12 are optionally directed in about the same angle relative to gravity, however, any suitable angles for any of the disclosed vertically oriented cameras may be used.

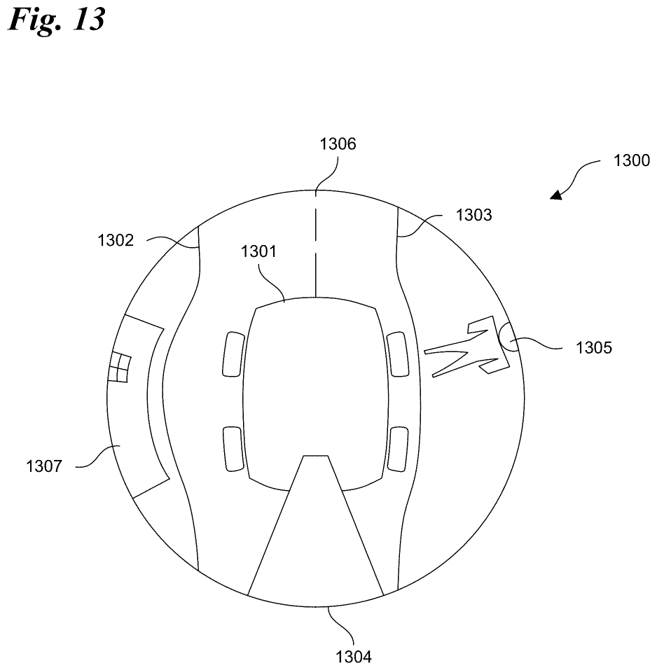

In another aspect, a vertically oriented camera of the present disclosure may include a wide-angle or fisheye lens directed vertically toward the vehicle and mounted above the vehicle. An example of a resulting field-of-view that may be defined by such a camera lens is illustrated at 1300 in FIG. 13. A vehicle 1301 of the present disclosure optionally appears at or near the center of the image, and a portion of the mount holding the camera may be visible at 1304. Objects within a predetermined distance from the vehicle in any direction may be visible within the field of view 1300. The maximum viewing distance may be defined according to physical properties of the lens, the height above the vehicle, and other parameters. These parameters may be stored and used by software modules, or other aspects of the control circuit in determining what path to take. For example, the field of view 1300 may include people standing nearby at 1305, markings, labels, words, or other objects in front of or behind the vehicle 1306, as well as path boundaries 1302 and 1303, buildings, or other nearby obstacles 1307 and the like. In another aspect, most, if not all, of the vehicle 1306 may be visible in the field of view 1300. The fisheye lens used may optionally capture a field of view that includes 180 degrees front to back and side to side relative to the vehicle 1301.

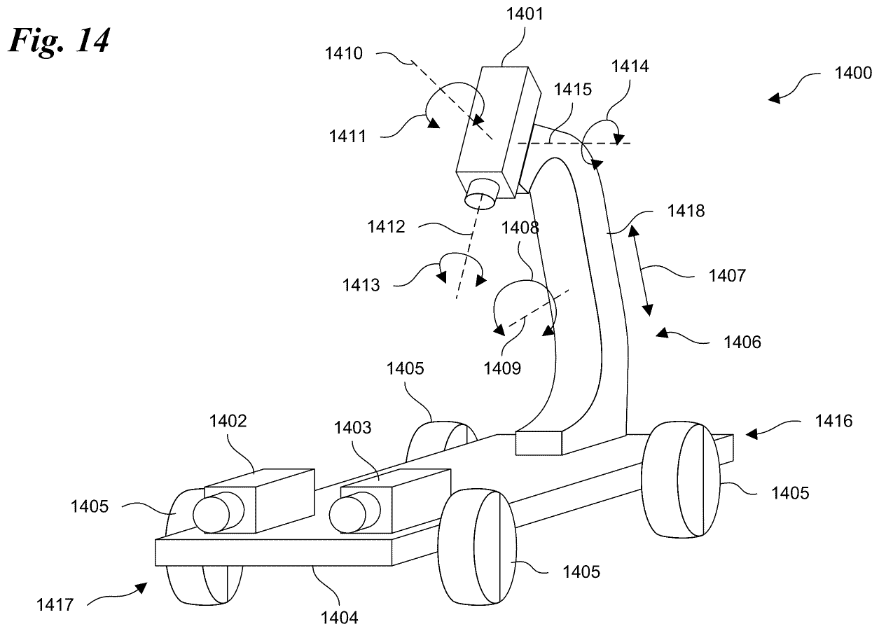

In another aspect, the cameras of the present disclosure may be rigidly mounted to the vehicle with a fixed field of view relative to the vehicle, or moveably mounted and generally repositionable to allow for infinitely adjustable fields of view relative to the vehicle. One example of a vehicle with multiple camera mounts according to the present disclosure is illustrated in FIG. 14 at 1400. In this example, the vehicle 1400 includes multiple cameras of differing and adjustable orientations, and four ground engaging wheels 1405 are optionally mounted to the frame as well. In one aspect, the camera system of FIG. 14 includes two horizontally oriented forward facing cameras 1402 on the vehicle right side, and 1403 on the vehicle left side. The cameras 1402 and 1403 are optionally rigidly mounted to a frame assembly 1404 adjacent to the front of the vehicle 1417. In this example, cameras 1402 and 1403 are fixed in position relative to the frame 1404 and are not adjustable or repositionable.

A third vertically oriented camera 1401 is optionally mounted to an adjustable mounting assembly at 1406. The adjustable mounting assembly 1406 may be coupled to the frame 1404 adjacent to the rear of the vehicle at 1416. The adjustable mount assembly 1406 illustrates multiple adjustments that may be included. In one aspect, the overall height of camera 1401 above the vehicle frame 1404 may be adjusted as shown by telescoping the arm 1418 up or down as shown at 1407. The arm 1418 may optionally be rotatable around one or more axis such as in the direction shown at 1408 around the axis 1409. Multiple other axes of rotation may be included as well allowing the arm 1418 to be rotatable in other directions as well.

Camera 1401 may also be rotatable as indicated at 1411 around an axis 1410 that generally corresponds with the Y-axis (up/down in the field of view). In another aspect, the adjustable mount assembly 1406 may also be configured to allow the camera 1401 to rotate as shown at 1414 around the axis 1415 which generally corresponds to the Z-axis (left and right in the field of view). The vertically oriented camera 1401 may also be rotatable as indicated at 1413 around an axis 1412 that generally corresponds with the X-axis (directly into and out of field of view). In another aspect, the mount assembly 1406 may be configured to adjust its position forward and backward on the frame 1404.

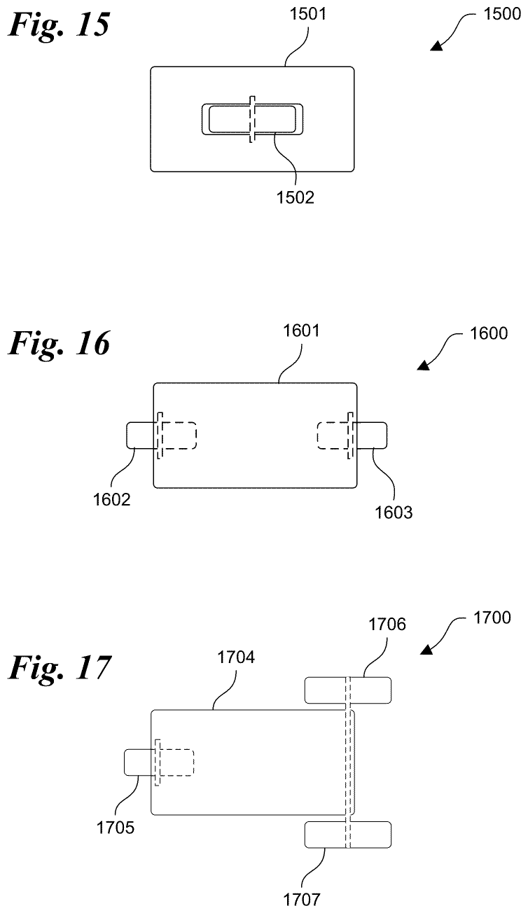

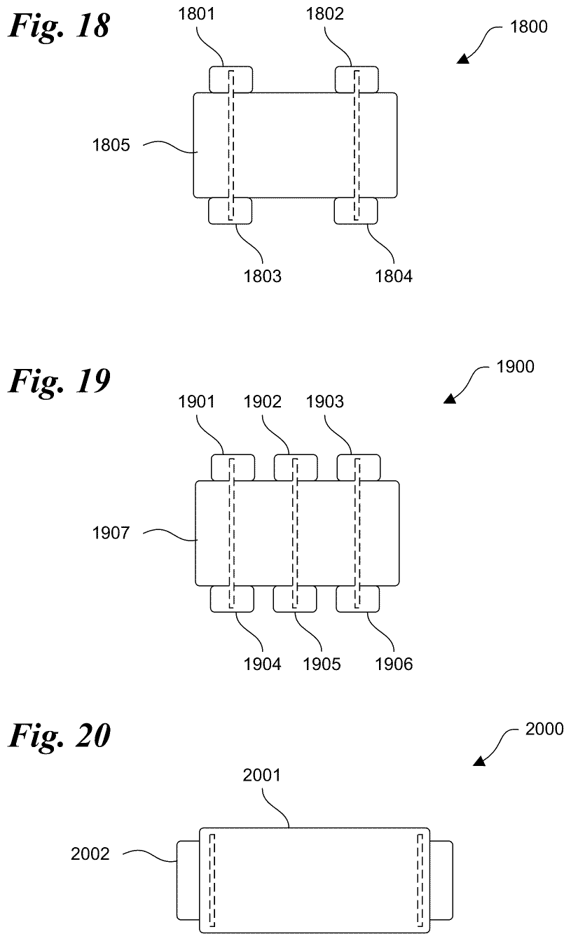

Illustrated in FIGS. 15-24 are one or more examples vehicles of the present disclosure. Vehicle of the present disclosure include those having one or more wheels, tracks, or other ground engaging elements, as well as propellers, screws, or other aspects for providing propulsion. Illustrated at 1500 in FIG. 15 is a vehicle 1501 optionally having a single wheel 1502. In FIG. 16, a vehicle 1601 is illustrated as optionally having two wheels 1602, and 1603. In FIG. 17, a vehicle 1704 optionally includes three wheels 1705, 1706, and 1707. In FIG. 18, a vehicle of the present disclosure may include four wheels 1801, 1802, 1803, 1804. In FIG. 19, another example of the vehicle of the present disclosure is shown where vehicle 1907 optionally includes six wheels 1901-1906.

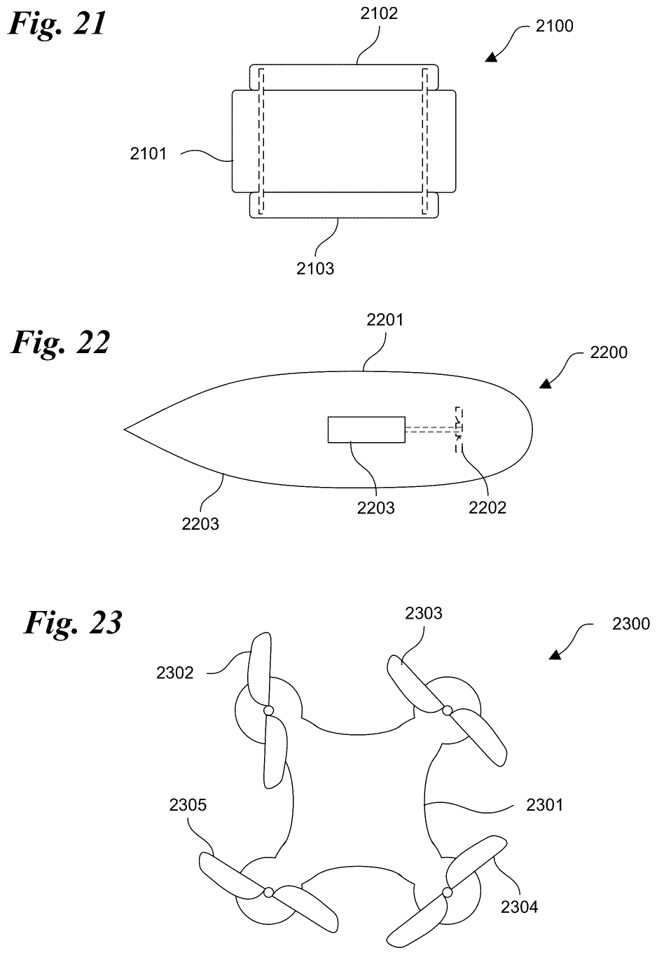

In FIG. 20, at 2000 is illustrated a vehicle 2001 the present disclosure that includes a single continuous track or belt 2002. In another example illustrated in FIG. 21, at 2100, a vehicle 2101 includes two continuous tracks or belts, a right track 2102, and left track 2103. In FIG. 22, a waterborne vehicle 2201 of the present disclosure is shown having a propulsion system 2203 with one or more screws 2202 engaging the water upon which the vehicle optionally floats. In FIG. 23, at 2300 is shown an airborne vehicle 2301 such as an aircraft, drone, dirigible, glider, and the like, having one or more propellers 2302-2305 operable to raise the aircraft into the air.

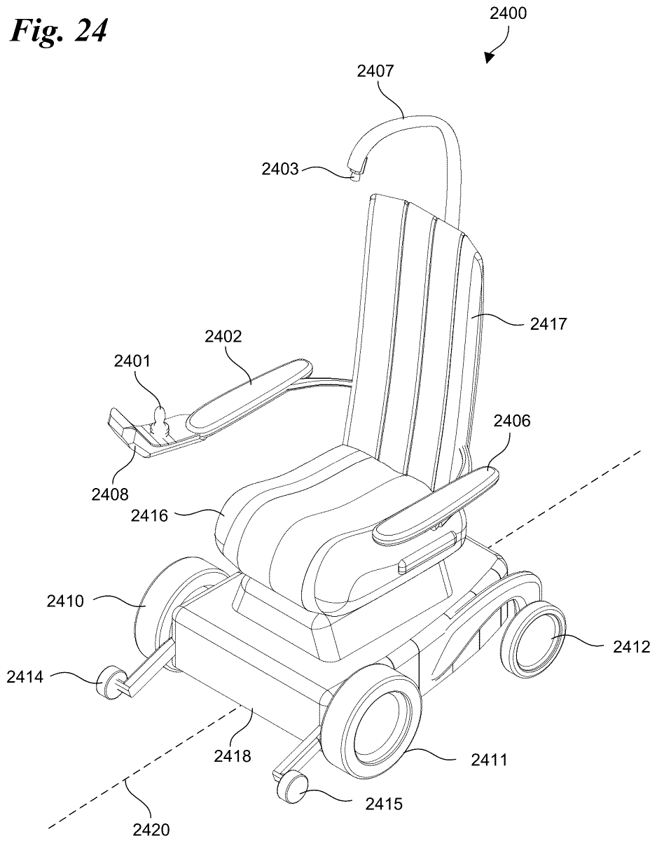

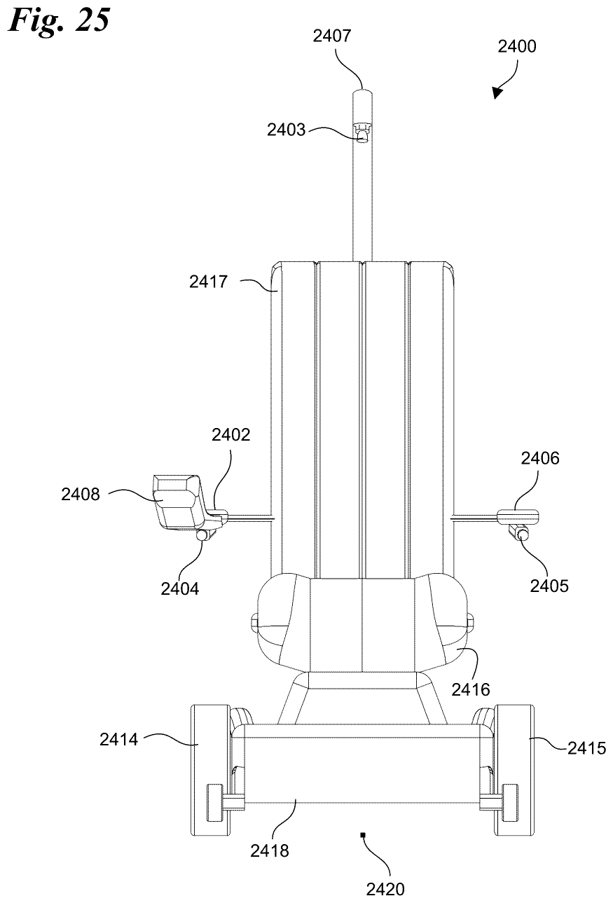

Illustrated in FIGS. 24-35 illustrate aspects of another example of a vehicle of the present disclosure. In this example, the vehicle is an electric powered wheelchair. In another aspect, the wheelchair illustrates the example of a guidance system accepting input from a camera system of the present disclosure. The disclosed guidance system is operable to autonomously, or semi-autonomously control a vehicle (such as a wheelchair) based on input received from a camera system of the present disclosure. The cameras may be mounted and moved, rotated, twisted, or otherwise repositioned to any suitable location, either before, during, or after mounting cameras to the wheelchair. According to the techniques of the present disclosure, the cameras may operate effectively to provide suitable guidance input irrespective of any particular precise location on the wheelchair, or changes thereto. The disclosed guidance system is operable to determine a path for the wheelchair while obtaining input from a multitude of variable and infinitely adjustable fields of view relative to the wheelchair (or any vehicle the present disclosure). In another aspect, because the input to the guidance system does not require specific points for the cameras, moving the cameras to different locations on the wheelchair may mean little if any recalibration of the control logic is required for subsequent operation. Thus the cameras are generally repositionable and may continue to operate with little to no operational deficit after being bumped out of alignment or accidentally pointed in a slightly different direction.

Illustrated in FIGS. 24-28 is a wheelchair 2400 arranged and configured, and generally operable according to the principles of the present disclosure. Throughout the present disclosure, the term “operator” includes a person riding in the wheelchair, and/or another person operating a remote controller, or remote personal computing device that is in communication with the wheelchair and is operable to accept input for controlling the wheelchair remotely. Thus in some instances, the “operator” as used herein includes the combination of both a person riding in the chair, and a nearby caregiver or other individual.

The wheelchair 2400 optionally includes an input device 2401 operable to accept input from an operator (in this instance the person riding in the chair) for controlling the direction and speed of the wheelchair. In this example, the input device includes a multidirectional joystick and the input is obtained when the operator manipulates the joystick. In this instance, the input device 2401 is optionally mounted to a right arm rest 2402, although the left arm rest 2406 is another optional location.

In another aspect, the input device 2401 may be included along with a controller 2408 which may be configured to accept input from the operator and provide output to the operator via a display device or other user interface. Other types of input devices may be used along with, or instead of, input device 2401. As disclosed herein elsewhere, numerous other types of input devices may be used with the wheelchair of the present disclosure to provide speed and directional input. In general, the input device is coupled to the wheelchair, and the control input received from the input device is provided by the operator of the wheelchair.

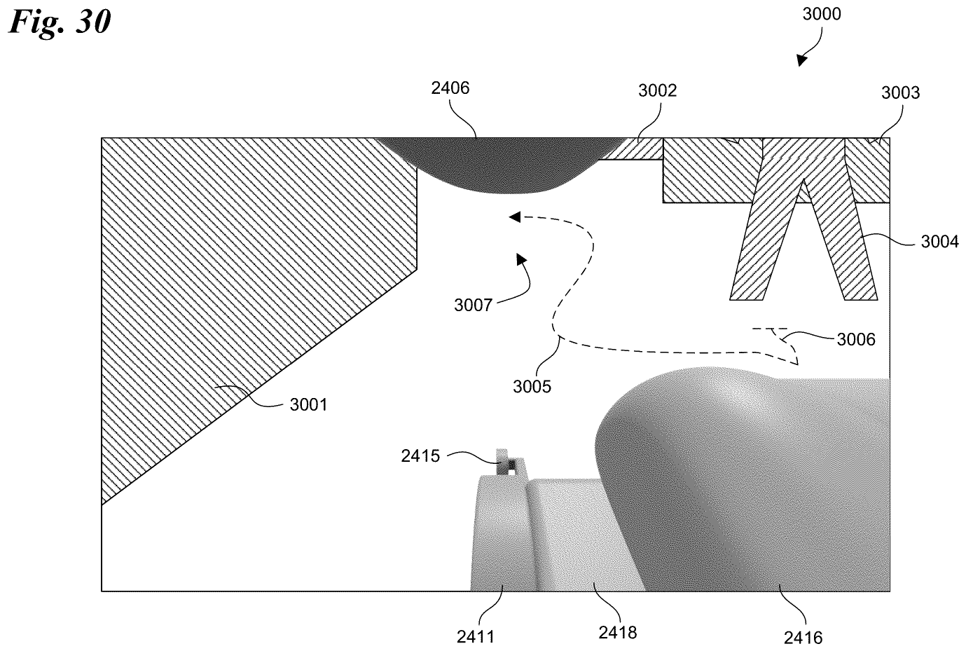

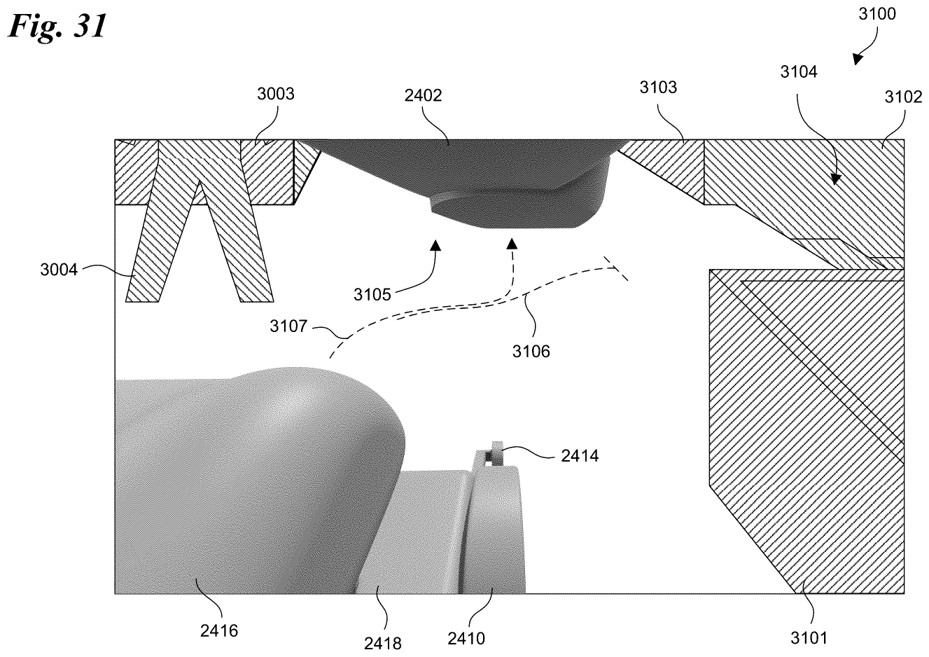

In another aspect, a camera assembly of the present disclosure is optionally mounted to the wheelchair 2400 that may include multiple cameras. These cameras include, but are not limited to, multiple forward facing cameras 2404 and 2405, as well as a downward facing camera 2403. As seen in FIGS. 30-31, the multiple cameras are arranged configured to define corresponding fields of view that are optionally different for each camera. A camera 2404 is optionally mounted beneath the right arm rest 2402, and a second camera 2405 is optionally mounted under the left arm rest 2406. In this configuration, cameras 2404 and 2405 optionally do not extend beyond the sides of the wheelchair. This may be advantageous to minimize the physical width of the chair 2400 so as to reduce or eliminate the possibility that the chair 2400 is too wide to pass through narrow doors, hallways, and the like. Camera 2403 is optionally mounted above the seat 2416 on a vertical upward extending camera mount 2407.

In another aspect, wheelchair 2400 is optionally self-propelled and has wheels, tracks, or other earth engaging elements such as wheels 2410-2415. The wheels are arranged and configured to support the chair above the support surface and/or to propel the chair in a forward direction (in the direction an operator normally faces while seated in the chair), in a rearward or reverse direction (the direction opposite the forward direction), or rotationally by applying steering control to wheels 2412 and 2413, or by applying counter-rotating drive commands to the wheels 2410 and 2411. For example, wheels 2410 and 2411 maybe operable as primary drive wheels delivering torque from the drive system to the ground and optionally providing steering control. Wheels 2412 and 2413 may be included to provide additional support for the rear of the wheelchair and optionally may be actively pivotable by the drive system to provide steering control, or passively pivotable to provide support. In another aspect, wheels 2414 and 2415 may be included for support to reduce or eliminate the possibility of the wheelchair tilting too far forward.

Other aspects of the wheelchair 2400 include a seat 2416 arranged and configured to support the operator, and a back rest 2417 arranged and configured to support the back of the operator. They base 2418 provides a frame operable to support the weight of the operator and provide a mount for wheels, motors, batteries, and the like. In another aspect, a center line 2420 is illustrated in FIGS. 24-26 and is generally aligned with the center of the base 2418.

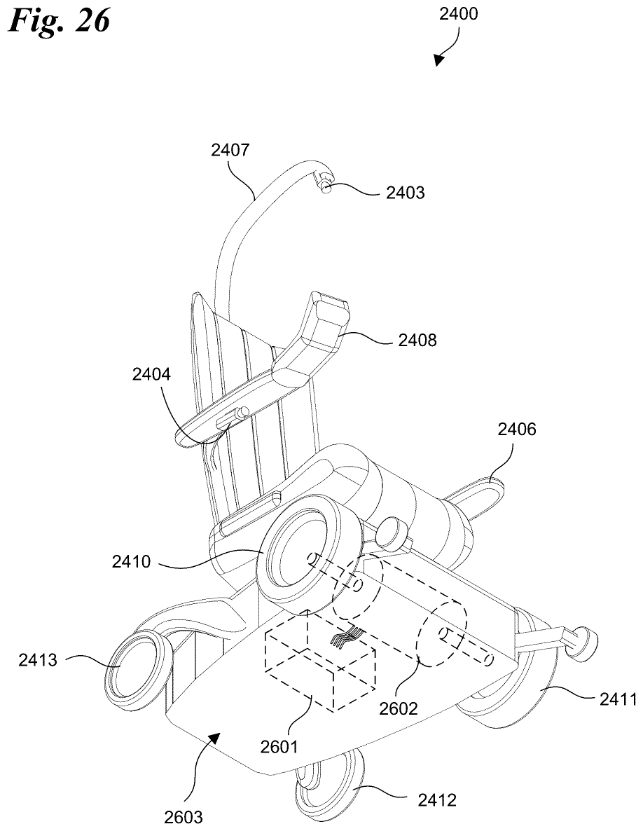

As shown in FIG. 26, the wheelchair 2400 optionally includes a drive system 2603 for providing power and mobility to wheelchair 2400. The drive system 2603 includes a drive train 2602 that optionally includes one or more electric motors that may be coupled to one or more drive wheels such as wheels 2410 and/or 2411. A transmission comprising multiple gear ratios may be included in the drivetrain 2602 as well. Drive system 2403 optionally includes a battery 2601 that may be electrically connected to the motor(s) 2602 to provide power to the motors, as well as other aspects of the wheelchair.

The drive system 2603 is optionally controlled by a vehicle control system which may include a control circuit 2807 of the present disclosure. The control circuit 2807 may include processors, memory, control logic, decision-making models, or other aspects for controlling the wheelchair 2400. The control circuit 2807 is optionally included in controller 2408 may be configured to accept input from input devices such as input device 2401, image data from cameras 2403-2406, sensor input from sensors mounted to the wheelchair, operational status information from the drive system 2603, and the like.

As illustrated in FIG. 24-28, the camera system included in wheelchair 2400 optionally includes multiple cameras 2403-2405 pointed in different directions and thus optionally defining differing fields of view. The cameras mounted to wheelchair 2400 may, for example be rigidly mounted and configured with fixed fields of view relative to portions of the wheelchair. In another aspect, the cameras may be movably mounted so as to allow the fields of view of each camera to change if necessary. Including a portion of the wheelchair within the camera's field of view provides the control logic with a frame of reference for determining relative location of objects in the environment with respect to the chair, as well as for determining the width of openings through which the chair may be required to pass.

Some or all of the cameras may be forward facing. Examples of forward facing cameras include cameras 2404 and 2405 which may be arranged configured to define one or more forward fields of view, and/or one or more obliquely oriented forward facing fields of view. These fields of view may optionally capture one or more front portions of the wheelchair. In one aspect, the fields of view captured from cameras 2404 and 2405 may be mirror images of one another. In another aspect, the cameras 2404 and 2405 may be angled differently thus defining fields of view which capture different areas of the wheelchair.

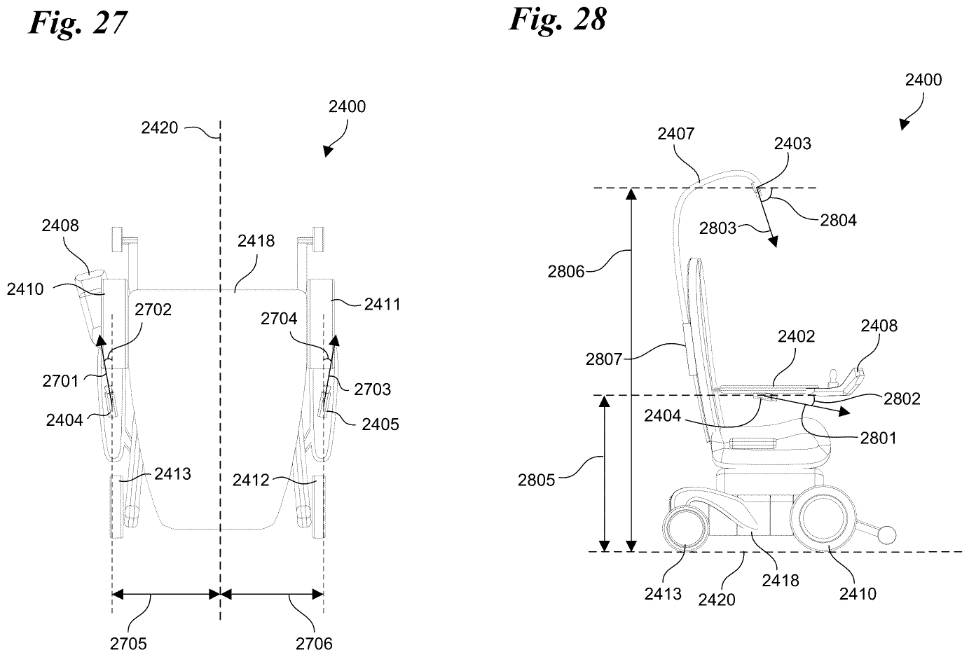

In another aspect, cameras 2404 and 2405 may be laterally offset from the center line 2420 is shown in FIG. 27. Camera 2404 may be arranged a distance 2705 from centerline 2420. In another aspect, camera 2404 is optionally angled slightly away from centerline 2420 by an angle 2702. Camera 2404 is thus directed horizontally as indicated at 2701. As discussed herein throughout, camera 2404 may be angled towards centerline 2420, away from it, or parallel to it. Camera 2405 may be arranged a distance 2706 from centerline 2420. In another aspect, camera 2405 is optionally angled slightly away from centerline 2420 by an angle 2704. Camera 2405 is thus directed horizontally as indicated at 2703. As discussed herein throughout, camera 2405 may be angled towards centerline 2420, away from it, or arranged to the parallel to it. In another aspect, cameras 2404 and 2405 may be offset front to back on the wheelchair where one camera may be positioned ahead of the other, or at about the same distance front to back as shown in FIGS. 27 and 28.

In another aspect, cameras 2404 and 2405 may be vertically offset and angled away from the horizontal as illustrated in FIG. 28. In one example, camera 2404 is arranged and configured to point in the direction shown at 2801 with respect to the horizontal 2420. In this configuration, camera 2404 is angled away from the horizontal by an angle 2802. As shown, angle 2802 directs camera 2404 downward, although other angles may optionally be more advantageous. Camera 2404 is optionally offset vertically by a distance 2805. This distance may be greater or less than what is shown as no particular vertical offset is required by the camera system of the present disclosure. In another aspect, camera 2404 may be vertically offset at a different height than camera 2405, or other cameras mounted to the wheelchair.

In another aspect, camera 2403 is optionally offset vertically by distance 2806 and is optionally arranged and configured to point in the direction indicated at 2803. In this configuration, camera 2403 is angled downwardly away from the horizontal by an angle 2804. The camera 2403 is thus directed toward portions of the wheelchair 2400 from a location that is above and generally centered front to back. As mentioned herein throughout, no particular camera position is necessarily required, and the position of camera 2403 is no exception. Camera 2403, like the other camera shown herein, may be positioned at any suitable angle with respect to the horizontal or vertical, or with respect to the rest of wheelchair 2400. Thus wheelchair 2400, like all other vehicles discussed in the present disclosure, optionally includes multiple cameras where any number of the cameras may be pointed in directions that differ from one or more other cameras. Thus the cameras may define fields of view that are different, similar, overlapping, the same, or any combination thereof suitable for providing adequate input to the disclosed control logic.

Wheelchair 2400, as well as other vehicles of the present disclosure, may include autonomous or semi-autonomous control aspects which optionally allow the vehicle to respond automatically to data and/or signals received from a wide variety of inputs including the camera systems of the present disclosure, other sensors, the vehicle itself, and the like. The disclosed pathfinding, navigation, and/or control aspects are generally applicable to all vehicles of the present disclosure.

Control circuit 2807 may be configured to automatically process and analyze the various data including the image data received from the multiple cameras, to determine exclusion zones or areas to avoid, and to determine one or more paths for the wheelchair. It may optionally determine control commands for the vehicle drive system that correspond to the path, and it may activate the vehicle drive system according to the control commands to propel the wheelchair along the path. The control circuit 2807 may thus provide real-time control of the vehicle's movements to reduce or eliminate input required by the operator of the wheelchair. Where an operator may be otherwise required to provide regular speed or directional input, the path discovery and autonomous navigational aspects of the present disclosure may reduce or eliminate the need for input from the operator while still providing a safe and comfortable ride as the wheelchair moves through the environment.

As will be discussed in more detail below, the path discovery and navigational behavior provided by control circuit 2807 may be provided without the aid of a location finding service, a map with predetermined waypoints, or input received from nearby beacons, or other wayfinding aids. The pathfinding and navigational aspects of the present disclosure are configured to operate free of these navigational aids optionally relying on visual data input received from the cameras.

The control circuit 2807 optionally includes control logic which may include decision-making models which are optionally configured using video data and human or other feedback to train the decision-making models to respond to a wide variety of situations in a safe, effective, and comfortable manner. The control circuit 2807 may thus be configured to determine a series of commands as output to the drive system for directing the vehicle's movements. The control logic may also be operable to determine a safe path around obstacles in the area, to avoid dangerous aspects of the environment, or to optionally bring the vehicle to a complete stop if no safe path may be found.

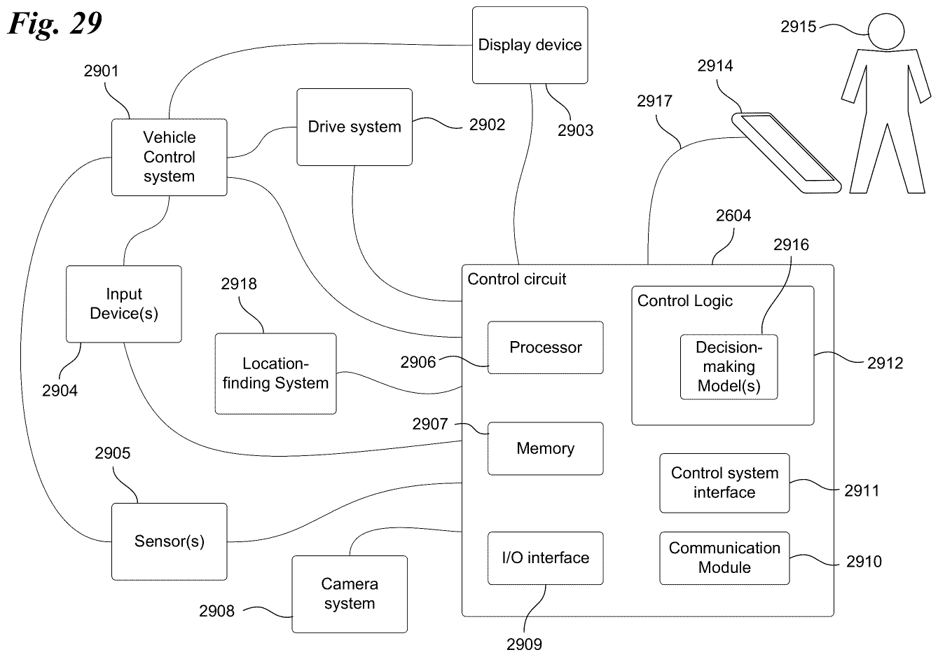

As disclosed herein, the control logic is operable to detect and respond to visual cues from the environment similarly to how a human would respond if experiencing the same visual cues. Such visual cues include street lights, pedestrian signals, lines on the pavement, cracks, frost heaved or other irregular surfaces, curbs, stairs, railings, and the like. Other examples include informational signs such as bathroom signs, wet floor warnings, street names, warning tape, red, blue, yellow, or other colored flashing lights such as might be used on emergency vehicles, construction barrels or cones, and other such informational or warning signs. The decision-making model(s) optionally controlling the wheelchair may be generally configured to behave autonomously without any human input, or semi-autonomously with some human input, so as to provide an experience for the operator that is the same as the operator might otherwise experience when the vehicle is fully under human. Aspects of these varying modes of control and other capabilities are illustrated in FIGS. 29-34 and discussed below.

FIG. 29 illustrates different systems that control circuit 2807 may interact with in providing the disclosed autonomous control capabilities. In one aspect, control circuit 2807 may be in communication with a vehicle control system 2901 which may be included in a vehicle of the present disclosure. In the case of wheelchair 2400, the vehicle control system may be included when the wheelchair is manufactured and may be configured to allow control circuit. 2807 to interact with it. For example, control circuit 2807 may be configured to operate as a node on a network specifically tasked with connecting sensors, controllers, motors, or other aspects of the vehicle to the vehicle control system 2901. One example of such a network is a Control Area Network (CAN), or an R-net™ network. In these examples, multiple aspects of a vehicle may communicate electronically via a shared protocol using a common communication bus (such as CANBUS or ReBus respectively). With this configuration, or with others like it, control circuit 2807 may be retrofitted to an existing vehicle control system 2901 so that the wheelchair or other vehicle that was manufactured to require human input may be upgraded with autonomous or semi autonomous control behavior according to the present disclosure. In another aspect, control circuit 2807 may be configured to augment and/or replace some or all aspects of vehicle control system 2901. In another aspect, control circuit 2807 may be included with the vehicle control system 2901 when the wheelchair is initially manufactured.

The control circuit 2807 (and the vehicle control system 2901) may be configured to receive input from sensors 2905, and/or from a camera system 2908 of the present disclosure.

The sensors may include any already discussed herein, such as sensor assembly 214, as well as any other sensors which may be included with wheelchair 2400. For example, sensors 2905 may include speed, direction, location, acceleration, tilt angle, or other aspects of the chair. Other Sensors which may be optionally included with a vehicle of the present disclosure, and/or in wheelchair 2400, include ultrasonic sensors which may be operable to detect stairs, walls, other nearby objects, as well as the orientation of the wheelchair, acceleration, speed, ambient light, temperature, humidity, sound, proximity to a predefined or predetermined target, and/or sensors configured to automatically determine a distance and/or proximity to a target or sensor worn by another person leading the wheelchair (or multiple wheelchairs). Sensor input from these and other sensors may be provided to control system 2901, and/or to control circuit 2807.

Control circuit 2807 may be operable to receive location finding input from a location finding system 2918. Location finding system 2918 optionally provides a real time indication of the location of the vehicle. Such location information may be used by the control circuit in order to track distance to a particular location, to provide a general direction vector to a particular location from the current location, or to provide other location specific services. Location finding system 2918 may use any suitable technology whether internal or external to the wheelchair for tracking the location of the vehicle such as the Global Positioning System (GPS), cellular communications, Wi-Fi, Bluetooth beacons, and/or a Real-Time Location System (RTLS), and the like. In one example, a location finding system 2918 may be engaged by the control circuit 2807 to determine a general heading to travel on such as in the case where an operator or other individual has directed the wheelchair to drive to a specific location on a map, but is leaving the control logic to find the best path to that location autonomously. This may be performed by the control logic without consulting a predefined map showing the location of obstacles and paths, and/or without a predefined list of waypoints generated in advance by a pathfinding algorithm.

In another aspect, control circuit 2807 may receive input from input devices 2904. Input devices optionally include, but are not limited to, devices operable to accept directional, speed, or other input from an operator of the wheelchair. These input devices may be configured to include a variety of input from the operator. Examples of input devices include, but are not limited to: a multi-directional joystick (such as input device 2401); a mouth tube configured to react to “sip” or “puff” actions taken by the operator; a head or neck input device operable to detect movements of the head; cameras configured to capture gestures that include movements of the fingers, hands, or other body parts; eye movement readers operable to detect movement of the eyes, blinking, and the like; microphones and/or voice recognition devices operable to detect and respond to verbal commands from the operator or other person; and/or neural sensors, neural implants, or other devices operable to capture neural activity. Any combination of these input devices may be responsive to input from the operator, and/or a nearby caregiver, or other individual, and may be accepted as input into the disclosed control logic and thereby translated into proportional control commands as output. These control commands may be passed to the vehicle control system 2901, and/or to control circuit 2807 (which may be one and the same).

In another aspect, the input devices optionally include at least one of the multiple cameras of the camera system 2908. In this example, the control input may be received as part of the image data. In one example, the control input optionally includes image data depicting a movement made by the operator or other nearby person expressing a command. These commands may include gestures, facial expressions, eye movement, movement of body parts such as fingers, hands, feet, head and the like. The control logic may be configured to detect these movements as specific input and to respond with corresponding outputs.

Other aspects of the control circuit 2807 include a processor 2906 which may optionally execute instructions implementing the control logic 2912. The control logic 2912 optionally includes one or more decision-making models 2916. These models include, but are not limited to, any suitable neural network, examples of which include a Convolutional Neural Network (CNN), a Transformer Model, a Large Language Model (LLM), or any other suitable artificial intelligence model configured to accept data inputs and to provide control outputs to the wheelchair, and any combination thereof.

The decision-making models 2916 may be configured according to any suitable programming, calibration, machine learning, or other method, or any combination thereof. In one aspect, the decision-making models may be trained according to any suitable method of machine learning. For example, an initial data set may be prepared that optionally includes video data and/or any of the inputs to the control logic discussed herein. The decision-making model may be trained by any suitable method using this initial dataset. The resulting trained model may then be installed and configured to provide control outputs to the wheelchair according to the inputs provided thus allowing the trained model(s) 2916 to attempt to autonomously determine safe and comfortable operation of the wheelchair, or other vehicle of the present disclosure, preferably in a new environment that is different than the environment used to train the model initially. Feedback from the results of operating the vehicle may then be fed back into the model using any suitable back propagation techniques, thus updating the decision-making model(s) based on real-world results. The model may thus be refined with repeated training to achieve higher degrees of accuracy, or to handle more and different types of inputs, thus resulting in decision-making modes that provide safer and more comfortable performance of the vehicle.

The process of training the decision-making models may be thought of as a learning process where the model is exposed to new, unfamiliar data in a series of controlled training exercises. The models are allowed to make predictions regarding choosing paths, speeds, responses to unexpected events, activation of safety features, and the like, and feedback regarding the outcomes is propagated back into the model to better adapt the decision-making paradigm implemented by the model to real-world experiences. In this way, the decision-making models 2916 may be ultimately configured, or reconfigured, to implement the disclosed functionality.

A memory 2907 may be included for optionally storing input data, calculated temporary or intermediary values, and/or output data values. Any portion of control logic 2912, such as the decision-making models 2916, may be stored in memory 2907. An I/O interface 2909 may be included for accepting input from connected systems or devices such as the camera system 2908, sensors 2905, location finding system 2918, display device 2903, and the like.

A control system interface 2911 is optionally included for managing communications to and from vehicle control system 2901. In one example, the control system interface 2911 includes transmitters, receivers, or other hardware and software for communicating with the vehicle control system, or with drive system 2902, input devices 2904, sensors 2905, or any other devices which may be configured to communicate using a predefined communication protocol via an internal control network such as CANBUS or ReBus.

A communication module 2910 may be included and arranged and configured to establish and/or maintain a communication link 2917 with a remote computing device 2914. The remote computing device 2914 may be operated by an operator 2915 which, as noted above, optionally includes the person riding the wheelchair, and/or a nearby person such as a caregiver who is available to offer assistance if needed. The remote computing device 2914 may be used as an input device that is remote from the wheelchair, and control input may be received from an operator 2915 that is also remote from the wheelchair. The operator 2915 may thus provide control commands to the wheelchair from a distance via a wireless communication link 2917. In another aspect, the control circuit is optionally configured to transmit image data obtained from the cameras of the camera system 2908 to the remote computing device 2914. In this instance, the operator or other individual 2915 may view the image data received by the cameras of the present disclosure, and the image data received may be received in real time as it is captured by the cameras, or it may be recorded by the computing device 2914 and accessed at a later time.

Autonomous functions implemented by the control logic 2916 include a number of different aspects which allow the wheelchair 2400, or any other vehicle the present disclosure, to receive visual cues from the environment, input from sensors, or from the vehicle itself, to determine a suitable safe path through the environment, and/or to deliver control commands to a drive system of the present disclosure that will cause the vehicle to navigate the environment according to the calculated path. This process happens continuously in real time as the vehicle navigates the environment, and with little or no preplanning, mapping, waypoint configurations, and the like.

Camera input according to the present disclosure is advantageously sufficient to provide navigational input in much the same way that human visual feedback is often sufficient for manual navigation. As discussed herein throughout, varying fields of view may be employed to achieve the desired visual input, and fields of view that include portions of the vehicle provide the control logic with a degree of self-awareness with respect to the location of the wheelchair with respect to other objects in the environment.

Some examples of the differing fields of view that may be obtained from different cameras according to the present disclosure are shown in FIGS. 29-33. These examples are illustrative rather than restrictive as any suitable fields of view, or combination thereof, may be used with the system of the present disclosure. FIG. 29 illustrates one example of a field-of-view 2900 that may be obtained from a camera that is offset to the left of center line of wheelchair 2400. This is an example of a view that may be defined by camera 2405 mounted under the left arm rest. This is also an example of a camera generally pointed downward and angled to the left that is also positioned to capture a front left portion of the wheelchair.

FIG. 30 illustrates an example of a field of view 3000 that is optionally obtained from a camera offset to the right of the centerline of the wheelchair. One example of such a camera is camera 2404 mounted under the right arm rest of the wheelchair and pointed downward and to the right so as to capture a right front portion of the wheelchair.

In another example, FIG. 31 illustrates a field-of-view 3100 that may be defined by a camera mounted above the wheelchair such as camera 2403. In this example, the camera captures some or all of the wheelchair from a vertical orientation pointing somewhat forward and angled downward from above the chair. This is one example of a field-of-view that captures the entire wheelchair. Other such views may be obtained by mounting cameras vertically or laterally offset from the chair and arranged and configured to look back towards the chair from other directions or heights.

FIGS. 30-34 illustrate different examples of multiple independent or overlapping fields of view that may be provided by cameras mounted at different locations on a wheelchair of the present disclosure, and which are pointed in different directions. The cameras may be arranged and configured to provide input to the disclosed navigation system for areas in front of, behind, or adjacent to the left or the right sides of the chair, and so forth. The control logic is optionally configured to use the image data obtained by the cameras to detect the presence of objects or other features in the environment that are represented in the image data, the relative distance to these objects or features, whether or not they are moving relative to the wheelchair, and if so, in which direction, and to modify the control commands accordingly.

In another aspect, FIGS. 30 and 31, and 33 and 34 illustrate examples of fields of view that include areas adjacent to the wheelchair that may not be visible from above. For example, frame members, armrests, or other objects extending away from the base or seat of the wheelchair may obscure areas adjacent to the vehicle. A clear view of these areas may be useful in determining the location of nearby objects. Thus the disclosed navigational aspects may be improved by positioning cameras so as to capture images from areas that may not be visible from a single camera mounted above. In another aspect, cameras mounted in different areas may advantageously obtain points of view looking forward, left, right, and so forth from a point of view closer to the ground thus providing additional visual feedback useful to the navigation system.

In one aspect, the control logic is configured to automatically calculate a series of control commands that will result in the wheelchair moving away from, or outside of, those areas the control logic has determined should be avoided. Determining a path (or multiple paths) for the wheelchair to pass through optionally includes calculating a series of control commands that will cause the drive system to move the wheelchair along the path. In another aspect, determining a path for the wheelchair optionally occurs before, during, or after activating the drive system. The visual cues obtained by the cameras and analyzed according to the disclosed control logic may be obtained at any time during the operation of the drive system. Thus it is not required for the vehicle to be in any predetermined position to start the journey, nor is it required for the cameras to be oriented in a particular direction, or arranged in a precise predetermined orientation for the control logic of the present disclosure to function properly.

The control logic of the present disclosure may defined (or be configured to provide) multiple different modes of operation. The control logic may include a “fully autonomous” mode where the control logic takes full control of the speed and direction of the vehicle, and any other vehicle systems such as warning lights, audible alarms, directional signal lights, head lamps, and the like. In fully autonomous mode, the vehicle is configured to move through the environment choosing a path toward any one of the available open areas at a default speed. This fully autonomous mode may continue until the control logic determines that some type of control input has been received via any of the disclosed input methods.

In another aspect, the control logic may define a “semi-autonomous” mode of operation where the control logic controls the speed and direction of the vehicle, but also accepts input from an operator and uses it to modify, or apply additional weight, to it's internal determinations regarding speed and direction. In semi-autonomous mode, the vehicle moves through the environment based on occasional input from the operator indicating general directional vectors such as by the occasional touch of the joystick, verbal input, gestures, occasional input from a remote operator, and the like. In semi-autonomous mode, the vehicle will move while avoiding obstacles, avoiding dangerous situations, while responding to occasional input provided by the operator.

The control logic may optionally provide a “shadow” mode where control of the vehicle is generally left to the operator. In shadow mode, the vehicle will remain stopped unless the operator provides input indicating the desired speed and direction. The vehicle will follow the commands provided by the operator except in those situations where doing so would cause a collision with an obstacle, person, pet, or other object, or would cause the vehicle to drive in an unsafe direction (such as off a ledge, into a fountain, pool, or other dangerous body of water, into a busy street, in direct disobedience of a traffic signal, etc.). Where a dangerous situation is detected by the control logic, the control logic is configured to take over control of the vehicle and apply appropriate speed, direction, braking, or other commands to the drive system to avoid the dangerous situation the vehicle is heading toward.

Control logic may also provide a “full manual” mode where control of the vehicle is left entirely to the operator. The control logic may provide visual cues that a dangerous situation is forthcoming, such as by flashing warning lights, making audible alarms, and the like. However, in full manual mode, the vehicle will respond to the direct input from the operator without intervention by the control logic. In another aspect, the wheelchair, or other vehicle of the present disclosure, may include a manual override switch configured to forcibly switch the control circuit from operating in fully autonomous, semi-autonomous, or shadow mode to manual mode. This may be advantageous in the unlikely event that the autonomous control logic causes erratic or unsafe behavior.

In another aspect, the control logic is configured to automatically determine speeds and trajectories for objects in the field of view of the cameras using the image data provided by the cameras. The control logic is configured to generate updated control commands adjusting forward speed and turn rate of the wheelchair accordingly as the vehicle moves. Aspects of this are illustrated in FIGS. 30-32. As discussed above, FIG. 30 provides one example of a field-of-view 3000 that may be captured by a camera placed under the left arm rest 2406 of wheelchair 2400. The seat 2416, based 2418, left wheels 2411 and 2415 may be included in the field of view according to the placement of the camera as discussed above.

The control logic optionally identifies exclusion or avoidance zones represented in the image data received from the cameras based on, for example, processing the image data through a neural network or other decision-making model as disclosed herein. Area 3001 in FIG. 30 may be identified by the control logic as an area to avoid to the left of the vehicle while areas to 3002 and 3003 may also be identified as areas to avoid further ahead of the vehicle. In another aspect, the control logic of the present disclosure may not be configured to determine what type of object is present, but rather only that the object is present and should be avoided. Similarly, the control logic may be configured to detect open areas such as halls, doorways, or other navigable areas that are free of obstacles, or potentially dangerous situations such as bodies of water, steep or uneven ground, stairways, and the like. In another aspect, the control logic of the present disclosure is configured to detect glass doors, windows, or walls constructed primarily of glass.

Another area to avoid may be 3004, a person standing in front of the vehicle, and potentially blocking its path. The system may not be configured to detect that 3004 is a person, but it is optionally configured to avoid that area because an object is present that it is configured to avoid. The control logic is optionally configured to automatically determine speeds and trajectories for objects in the field of view of the cameras using the image data, and to generate updated control commands adjusting the wheelchairs forward speed, turn rate, warning lights, or other relevant characteristics accordingly. The person standing at 3004 may be moving left or right, or standing still, and these characteristics are optionally detectable by the control logic and automatically adjusted for in real time as the wheelchair moves, and as the person may be moving as well. For example, if person 3004 is moving toward the wheelchair, the control logic may determine the best option is to stop the wheelchair, or optionally to turn left or right, or to optionally flash a warning light, or make a warning sound, or take any other suitable action as determined by the control logic.

In another aspect, the control logic is configured to identify open areas such as 3007 and to determine one or more paths like path 3005 and/or 3006. In order to steer clear of the areas to avoid/exclusion zones identified from the image data, the control logic may be configured to automatically steer along path 3005 making an initial left turn to avoid the person at 3004, and then a gentle right turn toward the open area at 3007, followed by another left turn down the hallway as shown. These calculations may be made well in advance and may be automatically modified as new objects appear in the field of view, or as existing objects move. In one aspect, the control logic may have indicated to the operator that an obstacle (such as the person 3004) is closer than a predetermined warning threshold distance, and this indication may be may by any suitable means such as by a flashing light, the appearance of an icon or other indicia on a display device of the controller mounted to the wheelchair, a verbal warning, a tactile warning such as a vibration, or by any other suitable means.

The control logic of the present disclosure is optionally configured to evaluate control input received from one or more input devices, and one or more operators, along with the image data when determining the upcoming sequence of control commands for the drive system. The input received by an input device of the present disclosure may be included in the path selection process, and may be weighted differently depending on the circumstances. For example, an operator may provide input indicating they would like the wheelchair to avoid the obstacle at 3004 by going left. This is an example of the wheelchair operating in “semi-autonomous” mode. The control logic may then automatically select path 3005 instead of some other path based on this additional input.

In another aspect, the operator may provide input via any suitable input device of the present disclosure indicating they would like the wheelchair to take the next available left (or right in other circumstances). In that instance, the control logic may be configured to consider the input provided by the operator along with all other inputs and elect to take path 3005 rather than any other path. The control input is received from the operator and the control logic is configured to evaluate this input and to pass the input to the drive system unless the control logic determines that operating the wheelchair according to the control input would result in the wheelchair entering an area it has determined to avoid.

In another aspect, the control logic may elect to move forward on pathway 3006 before coming to a stop. This path may be preferred such as in the instance where the person 3004 is gesturing toward the wheelchair to come towards them such as by beckoning to the wheelchair by a wave of the hand or by motion of the fingers. In this example, the cameras mounted to the wheelchair may be operable as input devices, and the control logic may be configured to determine the control input from the image data. For example, the control input may include image data depicting movements made by the operator or a nearby person expressing a command. The control logic may be configured to recognize the imagery obtained from the cameras as including gestures and it may be able to determine from these gestures a series of commands for the drive system.

The person at 3004 may also summon the wheelchair to come towards them via a verbal command such as “come here”, or “come closer”, and the like. This may be advantageous in a situation where the a nearby caregiver seeks to render aid to the person in the wheelchair, but the person in the wheelchair is not aware, or is unable to direct the chair in their direction. In another aspect, the control logic may be configured to determine caregivers separately from other individuals in the field of view. This determination may be made by configuring the logic to recognize the caregiver's voice, or by configuring it to detect shapes, indicia, patterns, colors, or other aspects of the caregivers clothing or appearance that are sufficient to differentiate them from others in the environment. For example, the caregiver may wear a uniform, or other clothing, that includes a recognizable pattern such as a QR code, logo, arrangement of colors and shapes, or any other distinguishable indicia.

As discussed in the present disclosure, multiple camera views may be processed simultaneously by control logic of the present disclosure. In FIG. 31, for example, a camera mounted on the right arm rest 2402 wheelchair 2400 may capture the field of view 3100 that includes the seat 2416, the base 2418, and right side wheels 2410 and 2414, as well as a portion of arm rest 2402. In this example, the field of view 3100 overlaps the field of view 3000 shown in FIG. 30. The person at 3004 and the far wall 3003 are both apparent in field-of-view 3100. Thus the control logic advantageously includes partially overlapping fields of view. Overlapping fields of view that also include portions of the vehicle may be useful to the control logic for improving accuracy of depth perception, better speed and distance perception, as well as an improved ability to determine the size of areas or objects in the field of view with respect to the size of the vehicle.

In the field of view 3100, additional areas to avoid are determined by the control logic. A wall at 3103 and 3102 is identified by the control logic, as well as a stairway at 3104. Thus the pathfinding aspects of the control logic are optionally configured to identify and avoid the stairs. In another aspect, the stairs may not be registered as an area to avoid where the wheelchair is configured to safely navigate stairs. The control logic optionally includes as inputs information about the specific model of the wheelchair and its inherent capabilities, such as whether or not the wheelchair can safely navigate stairs. Other avoidance zones include a nearby object at 3101 which may be a box, planter, or some other object.

The control logic may automatically navigate towards the open area 3105 which may include a hallway, doorway, or other such open space. The control logic may thus generate a series of steering and speed adjustments for a gentle right turn along path 3107 to avoid the obstacle at 3101, and the person at 3004, followed by a sharper left turn toward the open area 3105, thus also avoiding the stairs at 3104. In another example, the operator may request to advance toward the stairs 3104 along path 3106, by providing manual input to override the path selected by the control logic.

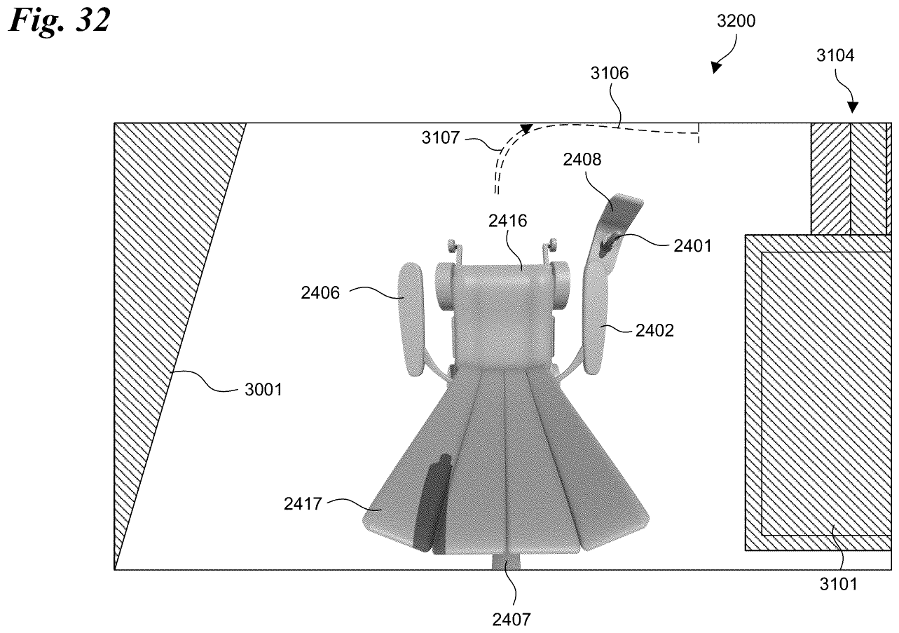

Yet another of the multiple camera views is illustrated in FIG. 32. A field-of-view 3200 is shown illustrating one example of the type of imagery that may be captured by a camera vertically mounted above the chair, such as camera 2403. The field-of-view 3200 optionally includes areas that overlap with fields of view captured by other cameras such as those illustrated in FIGS. 30 and 31. From the overhead vantage point of a downward pointing camera, areas to avoid 3001, 3104, and 3101 are also visible, along with the areas in front of, and adjacent to, the wheelchair. As with the other fields of view, control logic is configured to use the image data obtained by the cameras to detect the relative distances and trajectories of objects represented in the image data and to modify the control commands accordingly.

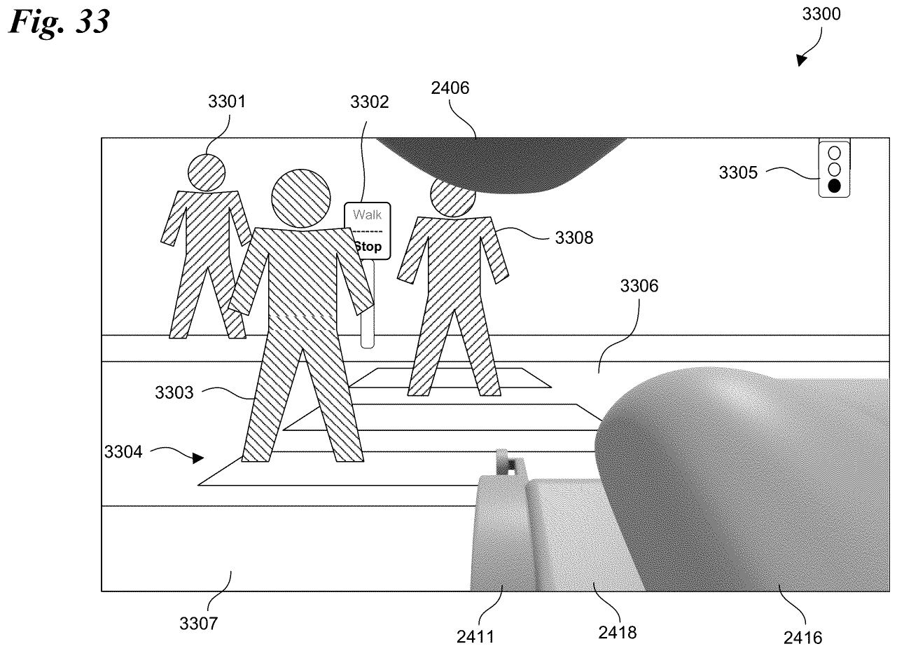

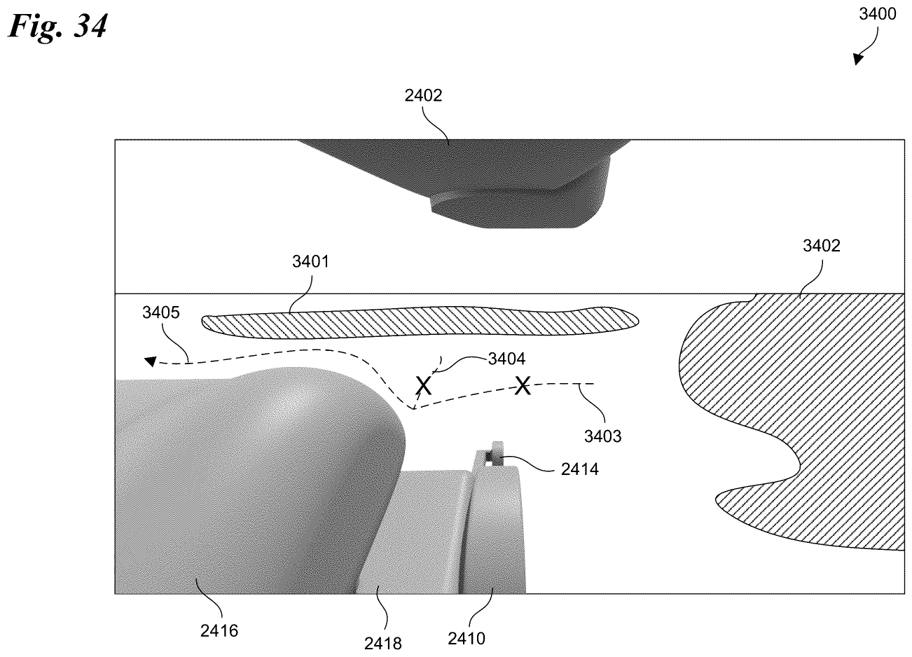

Other examples of visual cues that may be captured by the cameras of the present disclosure and recognized by the control logic disclosed herein are shown in FIGS. 33 and 34. In FIG. 33, a field-of-view 3300 may be captured by a forward facing camera such as camera 2405. In this example, the wheelchair 2400 is waiting on a sidewalk 3307 adjacent to a crosswalk 3304. The crosswalk 3304 is arranged to indicate where pedestrian traffic should cross the street 3306. In this example, the control logic is configured to detect that the crosswalk is present, but that it is not an exclusion zone per se. It is determined by the logic of the present disclosure as an “open” area safe for travel, absent other indicators to the contrary. Multiple people 3301, 3303, 3308 are present, and the control logic is configured to automatically determine those areas as exclusion zones. However, only two of the individuals 3303 and 3308 are in the crosswalk ahead, and thus ample room may be available for the wheelchair to avoid these individuals and cross the street. The control logic may, in this instance, determine that there are multiple optional paths around the people in the crosswalk. However, the control logic of the present disclosure is optionally configured to detect traffic signals based on the image data, to determine the state of the traffic signals, and to modify the control commands accordingly.

As shown in FIG. 33, two traffic signals have been detected by the control logic at 3302, and 3305. The traffic signal 3305 is displaying a green light which might be interpreted in some instances by the control logic as a signal to proceed. The presence of individuals 3303 and 3308 and the crosswalk 3304 may also be detected by the control logic and may also register as indication that the wheelchair can proceed forward across the street 3306. However, the control logic is configured to give less weight to the traffic signal 3305 and to more heavily weigh the input received from the signal 3302. This is because the control logic is optionally configured to recognize that signal 3302 is intended for pedestrians and that it is currently signaling to pedestrians that they should not cross (even though some are). Thus the wheelchair may be configured to remain in place rather than proceeding across the street. The wheelchair of the present disclosure is optionally configured to react to situations based on visual cues in a way similar to how a human should in the same situation.

In FIG. 34, a field-of-view 3400 may be captured by a forward facing camera such as camera 2404 mounted to the right armrest. In this example, the wheelchair 2400 is near a body of water 3402 such as a lake, fountain, swimming pool, or other such unnavigable area. The control logic has determined that this area 3402 should be avoided, as well as the uneven ground at 3401. The uneven ground at 3401 may be recognizable by the control logic of the present disclosure because it includes holes, drop-offs, deep or shallow depressions, broken received concrete or other uneven surfaces that may be dangerous for the wheelchair to attempt to travel through. In another aspect, some wheelchairs may include different wheels and drivetrains designed for uneven a rougher ground. The presence of these variations in the drive train of the wheelchair may be provided as input to the control logic. For example, the characteristics or capabilities of a particular wheelchair or other vehicle may be programmed into the control logic when the control circuit is installed in the wheelchair. These characteristics may be presented as input to the control logic and they may be then used by the control logic to determine which areas should be avoided, and what others can be safely traversed.

The control logic is optionally configured to consider multiple paths forward of which 3403-3405 are but a few examples. In this instance, the control logic optionally eliminates paths 3404 and 3403 from consideration because they will lead to entry into a zone that the control logic has determined should be avoided. In this example, the control logic elects the path 3405 and prepares a corresponding set of drive commands for the drive system of the wheelchair. These drive commands include a left turn and forward movement in the direction of the open area to the left away from the body of water 3402.

The control logic of the present disclosure is configured to ignore operator input that is nonsensical or unsafe are not safe. For example if the operator gives a command to go left when no left turn is available, the control logic is optionally configured to continue on its current path. Similarly, if the operator requests to go right where there is a staircase and then a doorway to the right, the control logic is optionally configured to avoid the stairway, continue along the current path until a safe righthand navigation (the doorway) presents itself. The control logic is thus configured to consider input provided by the operator without necessarily responding immediately where doing so would present harm to the operator or the vehicle, or both.

In another aspect, the control logic of the present disclosure effectively reduces, and possibly completely eliminates, the number of navigational inputs required from the operator for a given period of time. For example, to drive an electric wheelchair in full manual mode from one location through a busy environment such as a street or shopping mall requires regular or continuous steering and throttle inputs in order to navigate smoothly around obstacles and to yield to other people in the environment. According to the semi-autonomous or full autonomous modes of the present disclosure, the most important aspects of any trip can be communicated using minimal information (e.g. “go to the store around the corner”, or “meet me at the stairs”, etc.) and the control logic is operable to manage the numerous steering, braking, drive, and signaling commands that may be required to complete the trip. Only occasional corrective input may be necessary from the operator thus reducing the rate of interactions required by the operator, and the corresponding mental and physical work load it imposes.

In another aspect, the reduced inputs required to successfully navigate a complex environment allows operators with moderate to severe physical or mental limitations to successfully move about without concern for violating traffic laws, social norms, or endangering themselves or others because they lack the ability to provide continuous steering and drive commands to the wheelchair. This also may also remove a significant burden from caregivers who may be entrusted with operating the wheel chair and/or protecting the occupant as they move about. Using the disclosed system caregivers are not required to constantly monitor or provide control input for the wheelchair while it is in motion.

### CLAUSES

The following numbered clauses set out examples of the disclosed concepts that may be useful in understanding the present disclosure:

Clause 1: A vehicle that includes a drive system, a sensor assembly, and a control circuit, wherein the control circuit is responsive to the one or more sensors, and the drive system is responsive to the control circuit.

Clause 2: The vehicle of any preceding clause, wherein the drive system includes one or more ground contacting elements.

Clause 3: The vehicle of any preceding clause, wherein the drive system includes one or more propellers.

Clause 4: The vehicle of any preceding clause, wherein the drive system includes one or more wheels and/or tracks.

Clause 5: The vehicle of any preceding clause, wherein the drive system includes an electric motor generator and a battery assembly electrically connected thereto.

Clause 6: The vehicle of any preceding clause, wherein the drive system includes an internal combustion engine.

Clause 7: The vehicle of any preceding clause, wherein the drive system includes a transmission coupling a prime mover to one or more ground contacting elements.

Clause 8: The vehicle of any preceding clause, wherein the sensor assembly includes one or more cameras.

Clause 9: The vehicle of any preceding clause, wherein the sensor assembly includes one or more horizontally oriented cameras.

Clause 10: The vehicle of any preceding clause, wherein the sensor assembly includes one or more vertically oriented cameras.

Clause 11: The vehicle of any preceding clause, wherein the sensor assembly includes one or more cameras defining multiple separate and distinct fields of view.

Clause 12: The vehicle of any preceding clause, wherein the sensor assembly includes one or more cameras defining multiple overlapping fields of view.

Clause 13: The vehicle of any preceding clause, wherein the sensor assembly includes one or more cameras aligned parallel to a central axis of the vehicle.

Clause 14: The vehicle of any preceding clause, wherein the sensor assembly includes one or more cameras pointing away from a central axis of the vehicle.

Clause 15: The vehicle of any preceding clause, wherein the sensor assembly includes one or more cameras pointing toward a central axis of the vehicle.

Clause 16: The vehicle of any preceding clause, wherein the sensor assembly includes one or more cameras pointing away from a central axis of the vehicle.

Clause 17: The vehicle of any preceding clause, wherein the sensor assembly includes at least one camera defining a field of view that includes a portion of the vehicle.

Clause 18: The vehicle of any preceding clause, wherein the sensor assembly includes at least one camera defining a field of view that is free of any portion of the vehicle.

Clause 19: The vehicle of any preceding clause, wherein the sensor assembly includes at least one camera defining a field of view that includes the entire vehicle.

Clause 20: The vehicle of any preceding clause, wherein the sensor assembly includes at least one camera mounted adjacent a front end of the vehicle.

Clause 21: The vehicle of any preceding clause, wherein the sensor assembly includes at least one camera mounted above the vehicle.

Clause 22: The vehicle of any preceding clause, wherein the sensor assembly includes at least one camera mounted below the vehicle.

Clause 23: The vehicle of any preceding clause, wherein the sensor assembly includes at least one camera mounted within the vehicle.

Clause 24: The vehicle of any preceding clause, wherein the sensor assembly includes at least one camera mounted on an arm extending outwardly away from the vehicle.

Clause 25: The vehicle of any preceding clause, wherein the sensor assembly includes at least two cameras each defining a different field of view.

Clause 26: The vehicle of any preceding clause, wherein the sensor assembly includes at least one camera rigidly mounted to the vehicle.

Clause 27: The vehicle of any preceding clause, wherein the sensor assembly includes at least one camera that is configured to define multiple different fields of view.

Clause 28: The vehicle of any preceding clause, wherein the sensor assembly includes at least one camera that is mounted to the vehicle on a mount that is adapted to be titled, rotated, extended, or otherwise repositionable.

Clause 29: The vehicle of any preceding clause, wherein the sensor assembly includes at least two cameras positioned at different distances away from the vehicle.

Clause 30: The vehicle of any preceding clause, wherein the sensor assembly includes at least two cameras positioned at different distances away from a central axis or midline of the vehicle.

Clause 31: The vehicle of any preceding clause, wherein the sensor assembly includes at least two cameras extending laterally or vertically at different distances away from the vehicle.

Clause 32: The vehicle of any preceding clause, wherein the sensor assembly includes at least one camera that extends laterally beyond the sides of the vehicle.

Clause 33: The vehicle of any preceding clause, wherein the sensor assembly includes at least one camera that includes a lens defining an angle of view that is less than 180 degrees.

Clause 34: The vehicle of any preceding clause, wherein the sensor assembly includes at least one camera that includes a lens defining an angle of view that is less than 90 degrees.

Clause 35: The vehicle of any preceding clause, wherein the sensor assembly includes at least one camera that includes a lens defining an angle of view that is less than 10 degrees.

Clause 36: The vehicle of any preceding clause, wherein the sensor assembly includes at least one camera that defines a field of view that includes images from 360 degrees around the vehicle.

Clause 37: The vehicle of any preceding clause, wherein the sensor assembly includes a location finding services responsive to satellite, Wi-fi, beacon or cellular transmitters.

Clause 37: The vehicle of any preceding clause, wherein the sensor assembly includes a location finding services responsive to satellite, Wi-fi, beacon or cellular transmitters.

Clause 38: The vehicle of any preceding clause, wherein the sensors assembly includes sensors operable to detect any one or more of the following sense parameters in any combination: temperature, humidity, sound intensity, speed, attitude, and/or acceleration.

Clause 39: The vehicle of any preceding clause, wherein the sensors assembly includes ranging sensors operable to determine the distance from one or more nearby objects.

Clause 40: The vehicle of any preceding clause, wherein the sensors assembly includes ultrasonic sound transmitters and receivers operable to determine the range to nearby objects.

Clause 41: The vehicle of any preceding clause, wherein the sensors assembly includes Light Detection and Ranging (LIDAR) transmitters and receivers operable to determine the range to nearby objects.

Clause 42: The vehicle of any preceding clause, wherein the control circuit includes a processor, memory, and/or control logic operable to process input from one or more sensors of the vehicle.

Clause 43: The vehicle of any preceding clause, wherein the control circuit is configured to determine a response according to input received from one or more sensors.

Clause 44: The vehicle of any preceding clause, wherein the control circuit is configured to provide output to the drive system to control the actions taken by the vehicle in response to input received.

Clause 45: The vehicle of any preceding clause, wherein the control circuit is configured to determine a obstacles are present in the path of travel of the vehicle.

Clause 46: The vehicle of any preceding clause, wherein the control circuit is configured to determine a path around obstacles.

Clause 47: The vehicle of any preceding clause, wherein the control circuit is configured to detect environmental cues including street lights, pedestrian traffic signals, sidewalks, path boundaries such as lines, curbs, sidewalk edges, or any combination thereof.

The vehicle of any preceding clause, wherein the vehicle is a wheelchair.

The vehicle of any preceding clause, including a drive system operable to move the vehicle.

The vehicle of any preceding clause, including a camera assembly that includes multiple cameras defining multiple corresponding fields of view.

The vehicle of any preceding clause, wherein at least two of multiple corresponding fields of view include a portion of the vehicle.

The vehicle of any preceding clause, including a control circuit responsive to image data from the multiple cameras.

The vehicle of any preceding clause, wherein the control circuit includes control logic configured to automatically analyze the image data received from the multiple cameras to determine areas to avoid based on the image data.

The vehicle of any preceding clause, wherein the control circuit includes control logic configured to determine a path for the vehicle to pass through based on the image data.

The vehicle of any preceding clause, wherein the control circuit includes control logic configured to determine control commands for the drive system that correspond to a path.

The vehicle of any preceding clause, wherein the control circuit includes control logic configured to activate the drive system according to the control commands to allow the vehicle to move along the path.

The vehicle of any preceding clause, wherein the control logic is configured to automatically calculate a series of control commands that will result in the vehicle moving outside the areas to avoid.

The vehicle of any preceding clause, wherein determining a path for the vehicle to pass through includes calculating a series of control commands that will result in the vehicle moving along the path determined by the control logic.

The vehicle of any preceding clause, wherein determining a path for the vehicle occurs prior to activating the drive system.

The vehicle of any preceding clause, wherein the control logic is configured to automatically determine speeds and trajectories for objects in the field of view of the cameras using the image data.

The vehicle of any preceding clause, wherein the control logic is configured to generate updated control commands adjusting forward speed and turn rate of the vehicle accordingly.

The vehicle of any preceding clause, wherein the control logic includes a Convolutional Neural Network (CNN) configured to receive the image data as input and to detect objects based on the image data provided by the multiple cameras.

The vehicle of any preceding clause, wherein the control logic includes a transformer model configured to receive the image data as input and to determine the path for the vehicle.

The vehicle of any preceding clause, wherein the control logic is configured to detect doorways and hallways captured in the image data and to add the doorways and hallways to the path.

The vehicle of any preceding clause, wherein the control logic is configured to detect stairs and to add the stairs to the areas to avoid.

The vehicle of any preceding clause, wherein the control logic is configured to detect a swimming pool or other body of water and to add these bodies of water to the areas to avoid.

The vehicle of any preceding clause, wherein the control logic is configured to navigate the path without using location input from a location finding device.

The vehicle of any preceding clause, wherein the control logic is configured to navigate the path without using a predetermined route calculated prior to activation of the drive system.

The vehicle of any preceding clause, wherein the control logic is configured to detect traffic signals based on the image data, to determine the state of the traffic signals, and to modify the control commands accordingly.

The vehicle of any preceding clause, wherein the control logic is configured to detect the relative distance of objects represented in the image data, and to modify the control commands accordingly.

The vehicle of any preceding clause, wherein the cameras include at least one forward facing camera defining a forward field of view that includes front portions of the vehicle.

The vehicle of any preceding clause, where the cameras include at least one downward facing camera defining a downward field-of-view that captures at least a portion of the vehicle.

The vehicle of any preceding clause, including an input device operable to accept control input for the vehicle, wherein the control circuit is responsive to the input device,

The vehicle of any preceding clause, wherein the control logic is configured to evaluate the control input along with the image data when determining the control commands for the drive system.

The vehicle of any preceding clause, wherein the input device is coupled to the vehicle, and wherein the control input is provided by the operator of the vehicle.

The vehicle of any preceding clause, wherein the input device is remote from the vehicle.

The vehicle of any preceding clause, wherein the control input is received from an operator that is remote from the vehicle.

The vehicle of any preceding clause, wherein the control logic is configured to determine in advance when the control input received from the input device will result in the vehicle entering an area to avoid based on the image data, and to override the control input accordingly.

The vehicle of any preceding clause, wherein the input device includes at least one of the multiple cameras, wherein the control input is received as part of the image data.

The vehicle of any preceding clause, wherein the control input includes image data depicting a movement made by the operator or a nearby person expressing a command.

The vehicle of any preceding clause, wherein the input device includes at least one of the multiple cameras is arranged and configured to define a field-of-view that includes the eyes of an operator of the vehicle.

The vehicle of any preceding clause, wherein the control input includes image data capturing eye movement of the operator.

The vehicle of any preceding clause, wherein the control input includes speed and directional input.

The vehicle of any preceding clause, wherein the control logic is configured to determine a next left or right turn opportunity and to automatically turn upon receiving directional input from the operator.

The vehicle of any preceding clause, wherein the control logic is configured to determine a next left or right turn opportunity and to automatically turn upon receiving directional input from a remote computing device.

The vehicle of any preceding clause, wherein the control input is received from an operator of the vehicle, and wherein the control logic is configured to evaluate the control input and to pass the input directly to the drive system unless the control logic determines that operating the vehicle according to the control input would result in the vehicle entering an area to avoid.

The vehicle of any preceding clause, wherein the control circuit is configured to transmit image data obtained from the multiple cameras to a remote computing device.

### Glossary of Definitions and Alternatives

While the invention is illustrated in the drawings and described herein, this disclosure is to be considered as illustrative and not restrictive in character. The present disclosure is exemplary in nature and all changes, equivalents, and modifications that come within the spirit of the invention are included. The detailed description is included herein to discuss aspects of the examples illustrated in the drawings for the purpose of promoting an understanding of the principles of the invention. No limitation of the scope of the invention is thereby intended. Any alterations and further modifications in the described examples, and any further applications of the principles described herein are contemplated as would normally occur to one skilled in the art to which the invention relates. Some examples are disclosed in detail, however some features that may not be relevant may have been left out for the sake of clarity.

Where there are references to publications, patents, and patent applications cited herein, they are understood to be incorporated by reference as if each individual publication, patent, or patent application were specifically and individually indicated to be incorporated by reference and set forth in its entirety herein.

Singular forms “a”, “an”, “the”, and the like include plural referents unless expressly discussed otherwise. As an illustration, references to “a device” or “the device” include one or more of such devices and equivalents thereof.

Directional terms, such as “up”, “down”, “top” “bottom”, “fore”, “aft”, “lateral”, “longitudinal”, “radial”, “circumferential”, etc., are used herein solely for the convenience of the reader in order to aid in the reader's understanding of the illustrated examples. The use of these directional terms does not in any manner limit the described, illustrated, and/or claimed features to a specific direction and/or orientation.

Multiple related items illustrated in the drawings with the same part number which are differentiated by a letter for separate individual instances, may be referred to generally by a distinguishable portion of the full name, and/or by the number alone. For example, if multiple “laterally extending elements” 90A, 90B, 90C, and 90D are illustrated in the drawings, the disclosure may refer to these as “laterally extending elements 90A-90D,” or as “laterally extending elements 90,” or by a distinguishable portion of the full name such as “elements 90”.

Where applicable, actions or steps performed in a method are presumed to be optional and/or executable in any order, not necessarily only in the order described, unless specifically indicated otherwise. Method steps may be presented in a particular order in the accompanying drawings and detailed description, however, this is illustrative rather than restrictive, unless otherwise indicated. Method steps may be performed asynchronously, in parallel, synchronously, or in any suitable combination thereof.

The language used in the disclosure are presumed to have only their plain and ordinary meaning, except as explicitly defined below. The words used in the definitions included herein are to only have their plain and ordinary meaning. Such plain and ordinary meaning is inclusive of all consistent dictionary definitions from the most recently published Webster's and Random House dictionaries. As used herein, the following definitions apply to the following terms or to common variations thereof (e.g., singular/plural forms, past/present tenses, etc.):

“About” with reference to numerical values generally refers to plus or minus 10% of the stated value. For example, if the stated value is 4.375, then use of the term “about 4.375” generally means a range between 3.9375 and 4.8125.

“Activate” generally is synonymous with “providing power to”, or refers to “enabling a specific function” of a circuit or electronic device that already has power.

“And/or” is inclusive here, meaning “and” as well as “or”. For example, “P and/or Q” encompasses, P, Q, and P with Q; and, such “P and/or Q” may include other elements as well.

“Angle of View” generally refers to the measurement in degrees of an angle that defines the width, width, or diagonal length of a field of view. The angle of view can be measured on three planes: the horizontal angle of view, the vertical, or the diagonal. A small angle of view, measuring fewer degrees, means the field of view will include a narrower slice of the visible environment and will thus be “tighter” on the subject. A larger angle of view results in a field of view that includes more of the visible environment and will thus be “pulled back” from the subject. The angle of view is measured in degrees dictated by the focal length of a lens.

“Artificial Intelligence” generally refers to using a computer algorithm, or set of instructions, to simulate human intelligence processes by computer systems. Specific applications of AI include expert systems, natural language processing, speech recognition and machine vision.

“Camera” generally refers to a logical, virtual, or physical apparatus or assembly that generates or records images of a viewing area or field-of-view on a medium or in a memory. The images may be still images comprising a single frame or snapshot of the viewing area, or a series of frames recorded over a period of time that may be displayed in sequence to create the appearance of a moving image. Any suitable media may be used to store, reproduce, record, or otherwise maintain the images.

“Communication Link” generally refers to a connection between two or more communicating entities and may or may not include a communications channel between the communicating entities. The communication between the communicating entities may occur by any suitable means. For example, the connection may be implemented as an actual physical link, an electrical link, an electromagnetic link, a logical link, or any other suitable linkage facilitating communication.

In the case of an actual physical link, communication may occur by multiple components in the communication link configured to respond to one another by physical movement of one element in relation to another. In the case of an electrical link, the communication link may be composed of multiple electrical conductors electrically connected to form the communication link.

In the case of an electromagnetic link, the connection may be implemented by sending or receiving electromagnetic energy at any suitable frequency, thus allowing communications to pass as electromagnetic waves. These electromagnetic waves may or may not pass through a physical medium such as an optical fiber, or through free space, or any combination thereof. Electromagnetic waves may be passed at any suitable frequency including any frequency in the electromagnetic spectrum.

A communication link may include any suitable combination of hardware which may include software components as well. Such hardware may include routers, switches, networking endpoints, repeaters, signal strength enters, hubs, and the like.

In the case of a logical link, the communication link may be a conceptual linkage between the sender and recipient such as a transmission station in the receiving station. Logical link may include any combination of physical, electrical, electromagnetic, or other types of communication links.

“Computer” generally refers to any computing device configured to compute a result from any number of input values or variables. A computer may include a processor for performing calculations to process input or output. A computer may include a memory for storing values to be processed by the processor, or for storing the results of previous processing.

A computer may also be configured to accept input and output from a wide array of input and output devices for receiving or sending values. Such devices include other computers, keyboards, mice, visual displays, printers, industrial equipment, and systems or machinery of all types and sizes. For example, a computer can control a network or network interface to perform various network communications upon request. The network interface may be part of the computer or characterized as separate and remote from the computer.

A computer may be a single, physical, computing device such as a desktop computer, a laptop computer, or may be composed of multiple devices of the same type such as a group of servers operating as one device in a networked cluster, or a heterogeneous combination of different computing devices operating as one computer and linked together by a communication network. The communication network connected to the computer may also be connected to a wider network such as the internet. Thus, a computer may include one or more physical processors or other computing devices or circuitry and may also include any suitable type of memory.

A computer may also be a virtual computing platform having an unknown or fluctuating number of physical processors and memories or memory devices. A computer may thus be physically located in one geographical location or physically spread across several widely scattered locations with multiple processors linked together by a communication network to operate as a single computer.

The concept of “computer” and “processor” within a computer or computing device also encompasses any such processor or computing device serving to make calculations or comparisons as part of the disclosed system. Processing operations related to threshold comparisons, rules comparisons, calculations, and the like occurring in a computer may occur, for example, on separate servers, the same server with separate processors, or on a virtual computing environment having an unknown number of physical processors as described above.

A computer may be optionally coupled to one or more visual displays and/or may include an integrated visual display. Likewise, displays may be of the same type, or a heterogeneous combination of different visual devices. A computer may also include one or more operator input devices such as a keyboard, mouse, touch screen, laser or infrared pointing device, or gyroscopic pointing device to name just a few representative examples. Also, besides a display, one or more other output devices may be included such as a printer, plotter, industrial manufacturing machine, 3D printer, and the like. As such, various display, input and output device arrangements are possible.

Multiple computers or computing devices may be configured to communicate with one another or with other devices over wired or wireless communication links to form a network. Network communications may pass through various computers operating as network appliances such as switches, routers, firewalls or other network devices or interfaces before passing over other larger computer networks such as the internet. Communications can also be passed over the network as wireless data transmissions carried over electromagnetic waves through transmission lines or free space. Such communications include using WiFi or other Wireless Local Area Network (WLAN) or a cellular transmitter/receiver to transfer data.

“Computer Software”, or “Software” is an organized collection of bits representing computer instructions and data that tell the computer how to perform a series of actions. This is in contrast to physical hardware which is configured to actually perform the steps specified in the software. Examples include computer programs, libraries and related non-executable data, such as online documentation or digital media. Software includes processor specific instructions usually expressed as bits of binary data values signifying processor instructions that change the state of the computer from its preceding state. For example, an instruction may change the value stored in a particular storage location in the computer—an effect that is not directly observable to the user. An instruction may also invoke one of many input or output operations, for example displaying some text on a computer screen; causing state changes which should be visible to the user. The processor executes the instructions in the order they are provided, unless it is instructed to “jump” to a different instruction, or is interrupted by the operating system. As of 2015, most personal computers, smartphone devices and servers have processors with multiple execution units or multiple processors performing computation together, and computing has become a much more concurrent activity than in the past.

The majority of software is written in high-level programming languages. They are easier and more efficient for programmers because they are closer to natural languages than machine languages. High-level languages are translated into machine language using a compiler or an interpreter or a combination of the two. Software may also be written in a low-level assembly language, which has strong correspondence to the computer's machine language instructions and is translated into machine language using an assembler.

“Control circuit” or “Control Logic” or “Controller” generally refer to a device configured to alter the operating conditions of another device or system using any suitable means such as mechanical, hydraulic, pneumatic, electronic, or other aspects. These may include, but are not limited to, a microprocessor or computer, to monitor and physically alter the operating conditions of a given device or system.

In one aspect, a control circuit is optionally configured to provide signals or other electrical impulses that may be received and interpreted by the controlled device to indicate how it should behave. In another aspect, a control circuit may also be configured to accept input from and provide output to a wide array of input and output devices. Such devices include other computers, keyboards, mice, visual displays, printers, industrial equipment, and systems or machinery of all types and sizes.

A control circuit may be a single, physical, computing device such as a desktop computer or a laptop computer, or may be composed of multiple devices of the same type such as a group of servers operating as one device in a networked cluster, or a heterogeneous combination of different computing devices operating as one control circuit and linked together by a communication network. The communication network connected to the control circuit may also be connected to a wider network such as the Internet. Thus, a control circuit may include one or more physical processors or other computing devices or circuitry and may also include any suitable type of memory.

A control circuit may also be a virtual computing platform having an unknown or fluctuating number of physical processors and memories or memory devices. A control circuit may thus be physically located in one geographical location or physically spread across several widely scattered locations with multiple processors linked together by a communication network to operate as a single control circuit. Multiple control circuits or computing devices may be configured to communicate with one another or with other devices over wired or wireless communication links to form a network. Network communications may pass through various control circuits operating as network appliances such as switches, routers, firewalls or other network devices or interfaces before passing over other larger computer networks such as the Internet. Communications can also be passed over the network as wireless data transmissions carried over electromagnetic waves through transmission lines or free space. Such communications include using WiFi or other Wireless Local Area Network (WLAN) or a cellular transmitter/receiver to transfer data.

In one non-limiting example, the control circuit can include a Programmable Logic Control circuit (PLC), and Application Specific Integrated Circuit (ASIC), a Field Programmable Gate Array (FPGA), or other circuits incorporating these and other electronic components in any suitable arrangement such as diodes, transistors, logic gates, and the like. A control circuit may include a processor for performing calculations to process input or output. A control circuit may include a memory for storing values to be processed by the processor or for storing the results of previous processing.

For example, a control circuit may be operable to control a computer network or network interface to perform various network communications upon request. The network interface may be part of the control circuit, or characterized as separate and remote from the control circuit.

In another example, a control circuit may be configured to control a vehicle drivetrain for the purpose of directing the vehicles movements. The control circuit may be incorporated in the vehicle, or separate from it.

“Data” generally refers to one or more values of qualitative or quantitative variables that are usually the result of measurements. Data may be considered “atomic” as being finite individual units of specific information. Data can also be thought of as a value or set of values that includes a frame of reference indicating some meaning associated with the values. For example, the number “2” alone is a symbol that absent some context is meaningless. The number “2” may be considered “data” when it is understood to indicate, for example, the number of items produced in an hour.

Data may be organized and represented in a structured format. Examples include a tabular representation using rows and columns, a tree representation with a set of nodes considered to have a parent-children relationship, or a graph representation as a set of connected nodes to name a few.

The term “data” can refer to unprocessed data or “raw data” such as a collection of numbers, characters, or other symbols representing individual facts or opinions. Data may be collected by sensors in controlled or uncontrolled environments, or generated by observation, recording, or by processing of other data. The word “data” may be used in a plural or singular form. The older plural form “datum” may be used as well.

“Database” also referred to as a “data store”, “data repository”, or “knowledge base” generally refers to an organized collection of data. The data is typically organized to model aspects of the real world in a way that supports processes obtaining information about the world from the data. Access to the data is generally provided by a “Database Management System” (DBMS) consisting of an individual computer software program or organized set of software programs that allow user to interact with one or more databases providing access to data stored in the database (although user access restrictions may be put in place to limit access to some portion of the data).

In another aspect, the DBMS provides various functions that allow entry, storage and retrieval of large quantities of information as well as ways to manage how that information is organized. A database is not generally portable across different DBMSs, but different DBMSs can interoperate by using standardized protocols and languages such as Structured Query Language (SQL), Open Database Connectivity (ODBC), Java Database Connectivity (JDBC), or Extensible Markup Language (XML) to allow a single application to work with more than one DBMS.

In another aspect, a database may implement “smart contracts” which include rules written in computer code that automatically execute specific actions when predetermined conditions have been met and verified. Examples of such actions include, but are not limited to, releasing funds to the appropriate parties, registering a vehicle, sending notifications, issuing a certificate of ownership transfer, and the like. The database may then be updated when the transactions specified in the rules encoded in the smart contract are completely executed. In another aspect, the transaction specified in the rolls may be irreversible and automatically executed without the possibility of manual intervention. In another aspect, only parties specified in the rules of the smart contract who have been granted permission may be notified or allowed to see the results.

Databases and their corresponding database management systems are often classified according to a particular database model they support. Examples include a DBMS that relies on the “relational model” for storing data, usually referred to as Relational Database Management Systems (RDBMS). Such systems commonly use some variation of SQL to perform functions which include querying, formatting, administering, and updating an RDBMS. Other examples of database models include the “object” model, chained model (such as in the case of a “blockchain” database), the “object-relational” model, the “file”, “indexed file” or “flat-file” models, the “hierarchical” model, the “network” model, the “document” model, the “XML” model using some variation of XML, the “entity-attribute-value” model, and others.

Examples of commercially available database management systems include PostgreSQL provided by the PostgreSQL Global Development Group; Microsoft SQL Server provided by the Microsoft Corporation of Redmond, Washington, USA; MySQL and various versions of the Oracle DBMS, often referred to as simply “Oracle” both separately offered by the Oracle Corporation of Redwood City, California, USA; the DBMS generally referred to as “SAP” provided by SAP SE of Walldorf, Germany; and the DB2 DBMS provided by the International Business Machines Corporation (IBM) of Armonk, New York, USA.

The database and the DBMS software may also be referred to collectively as a “database”. Similarly, the term “database” may also collectively refer to the database, the corresponding DBMS software, and a physical computer or collection of computers. Thus, the term “database” may refer to the data, software for managing the data, and/or a physical computer that includes some or all of the data and/or the software for managing the data.

“Display device” generally refers to any device capable of being controlled by an electronic circuit or processor to display information in a visual or tactile. A display device may be configured as an input device taking input from a user or other system (e.g., a touch sensitive computer screen), or as an output device generating visual or tactile information, or the display device may configured to operate as both an input or output device at the same time, or at different times.

The output may be two-dimensional, three-dimensional, and/or mechanical displays and includes, but is not limited to, the following display technologies: Cathode ray tube display (CRT), Light-emitting diode display (LED), Electroluminescent display (ELD), Electronic paper, Electrophoretic Ink (E-ink), Plasma display panel (PDP), Liquid crystal display (LCD), High-Performance Addressing display (HPA), Thin-film transistor display (TFT), Organic light-emitting diode display (OLED), Surface-conduction electron-emitter display (SED), Laser TV, Carbon nanotubes, Quantum dot display, Interferometric modulator display (IMOD), Swept-volume display, Varifocal mirror display, Emissive volume display, Laser display, Holographic display, Light field displays, Volumetric display, Ticker tape, Split-flap display, Flip-disc display (or flip-dot display), Rollsign, mechanical gauges with moving needles and accompanying indicia, Tactile electronic displays (aka refreshable Braille display), Optacon displays, or any devices that either alone or in combination are configured to provide visual feedback on the status of a system, such as the “check engine” light, a “low altitude” warning light, an array of red, Yellow, and green indicators configured to indicate a temperature range.

“Drivetrain” generally refers to an intervening mechanism by which power is transmitted from a power source such as an engine, electric motor, or turbine to a load such as a drive wheel, propeller, generator, and the like.

“Electric Circuit” generally refers to the path followed by electrons from a generation source, through an electrical system, and returning to the source. An electric circuit may be open or closed. When an electric circuit is open, there is a break in the continuity of the circuit. As a result, the electrons are unable to flow. For example, when the wires of a circuit are disconnected the circuit is said to be open. When an electric circuit is closed, there is no break in the continuity of the circuit. As a result, the electrons are able to flow. For example, when the wires of a circuit are properly connected, with no breaks, the circuit is said to be closed.

“Electrically Connected” generally refers to a configuration of two objects that allows electricity to flow between them or through them. In one example, two conductive materials are physically adjacent one another and are sufficiently close together so that electricity can pass between them. In another example, two conductive materials are in physical contact allowing electricity to flow between them.

“Electromagnetic Energy” generally refers to a form of energy that can be reflected or emitted from objects through electrical or magnetic waves traveling through matter, through space, or any combination thereof. Electromagnetic energy comes in many examples including, but not limited to, gamma rays, x-rays, ultraviolet radiation, visible light, microwaves, radio waves and infrared radiation.

“Fisheye lens” generally refers to a very wide-angle lens with a field of view covering up to 180 degrees. A fish-eye lens produces strong visual distortion intended to create a wide panoramic or hemispherical image. Fisheye lenses achieve extremely wide angles of view, well beyond any rectilinear lens. Instead of producing images with straight lines of perspective (rectilinear images), fisheye lenses inherently apply angular distortion which gives images a characteristic convex non-rectilinear appearance.

“Circular” fisheye lenses generally take in a 180° hemisphere and project it as a circle within the field of view. By design, circular fisheye lenses thus cover a smaller image circle than rectilinear lenses designed for the same sensor size. The corners of a circular fisheye image will be completely black, and the image falls off quickly to black beyond a predetermined distance from the lens. Thus, by varying the focal length and position of the lens, the maximum distance at which objects are visible can be modified.

Unlike rectilinear lenses, fisheye lenses are not fully characterized by focal length and aperture alone. Angle of view, image diameter, projection type, and sensor coverage all vary independently of these. In another aspect, different fisheye lenses distort images differently, and the manner of distortion is referred to as their mapping function. A common type for consumer use is “equisolid” angle mapping. In another example, some circular fisheyes lenses are available in orthographic projection models for scientific applications. These have a 180° vertical, horizontal and diagonal angle of view.

“Graphics Processing Unit” or “GPU” generally refers to a specialized electronic circuit designed to manipulate and alter memory to accelerate the creation of images in a frame buffer intended for output to a display device. GPUs are optimized to manipulate computer graphics and perform image processing. Many GPUs have an internal parallel structure that makes them more efficient than general-purpose Central Processing Units (CPUs) for algorithms that process large blocks of data in parallel. This is especially true for data mapped in three-dimensional, or two-dimensional space, and/or data presented in single or multi-dimensional vector or matrix formats.

In some instances, a GPU may be useful for making calculations that do not result in a graphical output on a display device. For example, many deep learning, neural network, or other artificial intelligence algorithms perform calculations on data that is presented using multidimensional matrices. GPUs are generally optimized for these types of calculation and thus may be useful for performing calculations relevant to machine implemented automatic decision-making algorithms with or without any resulting graphical output.

A GPU can be present on a separate video card, embedded on a motherboard, or embedded on a CPU die. Thus, GPUs are useful in many different computing devices such as in embedded systems circuits, mobile phones, personal computers, workstations, and game consoles.

“Horizontal” generally means having an angle of incidence that is equal to or less than 45 degrees and equal to or greater than 0 degrees.

“Horizontally Oriented” generally refers to an orientation where a horizontal reference plane is substantially perpendicular or orthogonal to gravity.

“Input Device” generally refers to any device coupled to a computer that is configured to receive input and deliver the input to a processor, memory, or other part of the computer. Such input devices can include keyboards, mice, trackballs, touch sensitive pointing devices such as touchpads, or touchscreens. Input devices also include any sensor or sensor array for detecting environmental conditions such as temperature, light, noise, vibration, humidity, and the like.

“Large Language Model (LLM)” generally refers to a type of machine learning model that is optimized to achieve general-purpose language generation. LLMs acquire these abilities by learning statistical relationships from text documents during a computationally intensive training process. This training process may include self-supervised and semi-supervised training activities. LLMs are artificial neural networks, the largest and most capable of which are usually built with a transformer-based architecture while implementations are based on other architectures, such as recurrent neural. LLMs can be used for text generation, a form of generative AI, by taking an input text and repeatedly predicting the next token or word.

“Location Finding System” generally refers to a system that tracks the location of objects or people in real time. Such systems include space based systems like the Global Positioning System (GPS) which may use a receiver on earth in communication with multiple satellite mounted transmitters in space. Such systems may use time and the known position of the satellites to triangulate a position on earth. The satellites may include accurate clocks that are synchronized to each other and to ground clocks. The satellites may be configured to continuously transmit their current time and position. The ground-based receiver may monitor multiple satellites solving equations in real time to determine the precise position of the receiver. Signals from four satellites may be required for a receiver to make the necessary computations.

In another example sometimes referred to as “Real-time Locating Systems” (RTLS), wireless tags are attached to objects or worn by people. Receivers maintained at known, fixed reference points may receive wireless signals from the tags and use signal strength information to determine their location.

The tags may communicate using electromagnetic energy which may include radio frequency (RF) communication, optical, and/or acoustic technology instead of or in addition to RF communication. Tags and fixed reference points can be transmitters, receivers, or both. Location information may or may not include speed, direction, or spatial orientation, and may in some cases be limited to tracking locations of objects within a building or contained area.

Wireless networking equipment may be engaged as well. In one example, known signal strength readings may be taken in different locations serviced by a wireless network such as in 802.11 Wi-Fi network. These known signal strength readings may be used to calculate or triangulate approximate locations by comparing measured signal strength received from a tag against a stored database of Wi-Fi readings or Received Signal Strength Indicators (RSSI). In this way, one or more probable locations may be indicated a virtual map.

In another example, a wireless network transmitter may be configured to send reference signal strength information in packets or datagrams received by the tags. The tags may be configured to measure and/or calculate the actual signal strength of the signal received from the sending transmitter and compare this actual signal strength to reference signal strength information to determine an approximate distance from the transmitter. This distance information may then be sent to other servers or components in the location finding system and used to triangulate a more precise location for a given tag.

“Memory” generally refers to any storage system or device configured to retain data or information. Each memory may include one or more types of solid-state electronic memory, magnetic memory, or optical memory, just to name a few. Memory may use any suitable storage technology, or combination of storage technologies, and may be volatile, nonvolatile, or a hybrid combination of volatile and nonvolatile varieties. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM).

Memory can refer to Dynamic Random Access Memory (DRAM) or any variants, including static random access memory (SRAM), Burst SRAM or Synch Burst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (REDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM).

Memory can also refer to non-volatile storage technologies such as non-volatile read access memory (NVRAM), flash memory, non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Domain Wall Memory (DWM) or “Racetrack” memory, Nano-RAM (NRAM), or Millipede memory. Other non-volatile types of memory include optical disc memory (such as a DVD or CD ROM), a magnetically encoded hard disc or hard disc platter, floppy disc, tape, or cartridge media. The concept of a “memory” includes the use of any suitable storage technology or any combination of storage technologies.

“Module” or “Engine” generally refers to a collection of computational or logic circuits implemented in hardware, or to a series of logic or computational instructions expressed in executable, object, or source code, or any combination thereof, configured to perform tasks or implement processes. A module may be implemented in software maintained in volatile memory in a computer and executed by a processor or other circuit. A module may be implemented as software stored in an erasable/programmable nonvolatile memory and executed by a processor or processors. A module may be implanted as software coded into an Application Specific Information Integrated Circuit (ASIC). A module may be a collection of digital or analog circuits configured to control a machine to generate a desired outcome.

Modules may be executed on a single computer with one or more processors, or by multiple computers with multiple processors coupled together by a network. Separate aspects, computations, or functionality performed by a module may be executed by separate processors on separate computers, by the same processor on the same computer, or by different computers at different times.

“Multiple” as used herein is synonymous with the term “plurality” and refers to more than one, or by extension, two or more.

“Network” or “Computer Network” generally refers to a telecommunications network that allows computers to exchange data. Computers can pass data to each other along data connections by transforming data into a collection of datagrams or packets. The connections between computers and the network may be established using either cables, optical fibers, or via electromagnetic transmissions such as for wireless network devices.

Computers coupled to a network may be referred to as “nodes” or as “hosts” and may originate, broadcast, route, or accept data from the network. Nodes can include any computing device such as personal computers, phones, servers as well as specialized computers that operate to maintain the flow of data across the network, referred to as “network devices”. Two nodes can be considered “networked together” when one device is able to exchange information with another device, whether or not they have a direct connection to each other.

Examples of wired network connections may include Digital Subscriber Lines (DSL), coaxial cable lines, or optical fiber lines. The wireless connections may include BLUETOOTH, Worldwide Interoperability for Microwave Access (WiMAX), infrared channel or satellite band, or any wireless local area network (Wi-Fi) such as those implemented using the Institute of Electrical and Electronics Engineers' (IEEE) 802.11 standards (e.g., 802.11 (a), 802.11 (b), 802.11 (g), or 802.11 (n) to name a few). Wireless links may also include or use any cellular network standards used to communicate among mobile devices including 1G, 2G, 3G, or 4G. The network standards may qualify as 1G, 2G, etc. by fulfilling a specification or standards such as the specifications maintained by International Telecommunication Union (ITU). For example, a network may be referred to as a “3G network” if it meets the criteria in the International Mobile Telecommunications-2000 (IMT-2000) specification regardless of what it may otherwise be referred to. A network may be referred to as a “4G network” if it meets the requirements of the International Mobile Telecommunications Advanced (IMTAdvanced) specification. Examples of cellular network or other wireless standards include AMPS, GSM, GPRS, UMTS, LTE, LTE Advanced, Mobile WiMAX, and WiMAX-Advanced.

Cellular network standards may use various channel access methods such as FDMA, TDMA, CDMA, or SDMA. Different types of data may be transmitted via different links and standards, or the same types of data may be transmitted via different links and standards.

The geographical scope of the network may vary widely. Examples include a body area network (BAN), a personal area network (PAN), a low power wireless Personal Area Network using IPV6 (6LoWPAN), a local-area network (LAN), a metropolitan area network (MAN), a wide area network (WAN), or the Internet.

A network may have any suitable network topology defining the number and use of the network connections. The network topology may be of any suitable form and may include point-to-point, bus, star, ring, mesh, or tree. A network may be an overlay network which is virtual and is configured as one or more layers that use or “lay on top of”′ other networks.

A network may utilize different communication protocols or messaging techniques including layers or stacks of protocols. Examples include the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer.

“Neural Network” generally refers to a collection of cooperating computational nodes implemented in hardware and/or software that use a mathematical or computational model for information processing based on a connectionistic approach to computation. A neural network may be an adaptive system that changes its structure based on external or internal information that flows through the network. The connections between nodes may be “weighted” to achieve specific outcomes given a wide range of inputs. A more positive weight reflects a more relevant or more “excitatory” connection, while a more negative weight reflects a more uninteresting or more “inhibitory” connections. All inputs to each node are modified according to the weights and summed. This activity is referred to as a linear combination. Finally, an activation function is generally used by each node to control the amplitude of the output. For example, an acceptable range of output is usually between 0 and 1, or it could be −1 and 1. The output of each node may then be fed as input to other nodes, and thus the overall network of nodes may be able to solve complex problems and/or to adapt to changes in the input over time.

These artificial networks may be used for predictive modeling, adaptive control and applications where they can be trained via a dataset. Self-learning resulting from experience can occur within networks, which can derive conclusions from a complex and seemingly unrelated set of information.

“Orthogonal” as used herein means intersecting or lying at right angles, plus or minus 5 degrees.

“Optionally” as used herein means discretionary; not required; possible, but not compulsory; left to personal choice.

“Output Device” generally refers to any device or collection of devices that is controlled by computer to produce an output. This includes any system, apparatus, or equipment receiving signals from a computer to control the device to generate or create some type of output. Examples of output devices include, but are not limited to, screens or monitors displaying graphical output, any projector a projecting device projecting a two-dimensional or three-dimensional image, any kind of printer, plotter, or similar device producing either two-dimensional or three-dimensional representations of the output fixed in any tangible medium (e.g., a laser printer printing on paper, a lathe controlled to machine a piece of metal, or a three-dimensional printer producing an object). An output device may also produce intangible output such as, for example, data stored in a database, or electromagnetic energy transmitted through a medium or through free space such as audio produced by a speaker controlled by the computer, radio signals transmitted through free space, or pulses of light passing through a fiber-optic cable.

“Perpendicular” as used herein means having an angle of incidence that is between 45 and 90 degrees.

“Personal computing device” generally refers to a computing device configured for use by individual people. Examples include mobile devices such as Personal Digital Assistants (PDAs), tablet computers, wearable computers installed in items worn on the human body such as in eyeglasses, watches, laptop computers, portable music/video players, computers in automobiles, or cellular telephones such as smart phones. Personal computing devices can be devices that are typically not mobile such as desk top computers, game consoles, or server computers. Personal computing devices may include any suitable input/output devices and may be configured to access a network such as through a wireless or wired connection, and/or via other network hardware.

“Portion” means a part of a whole, either separated from or integrated with it.

“Power Source” generally refers to a device or system for providing power. The power may be supplied electrically, mechanically, or by other suitable means. For example, a battery may operate as a power source. In another example, an internal combustion engine may be a power source. In another example, an electric motor may operate as a power source. In another example, a generator powered by combustion of hydrocarbons, nuclear fission, wind, falling water, tidal forces, and the like may be a power source. In yet another example, a solar array configured to collect energy from solar activity may be a power source. In another example, a voltage source, a current source, or a combination thereof may be considered a power source.

“Predominately” as used herein is synonymous with greater than 50%.

“Processor” generally refers to one or more electronic components configured to operate as a single unit configured or programmed to process input to generate an output. Alternatively, when of a multi-component form, a processor may have one or more components located remotely relative to the others. One or more components of each processor may be of the electronic variety defining digital circuitry, analog circuitry, or both. In one example, each processor is of a conventional, integrated circuit microprocessor arrangement, such as one or more PENTIUM, i3, i5 or i7 processors supplied by INTEL Corporation of Santa Clara, California, USA. Other examples of commercially available processors include but are not limited to the x8 and Freescale Coldfire processors made by Motorola Corporation of Schaumburg, Illinois, USA; the ARM processor and TEGRA System on a Chip (SoC) processors manufactured by Nvidia of Santa Clara, California, USA; the POWER7 processor manufactured by International Business Machines of White Plains, New York, USA; any of the Fx, Phenom, Athlon, Sempron, or Opteron processors manufactured by Advanced Micro Devices of Sunnyvale, California, USA; or the Snapdragon SoC processors manufactured by Qualcomm of San Diego, California, USA.

A processor also includes Application-Specific Integrated Circuit (ASIC). An ASIC is an Integrated Circuit (IC) customized to perform a specific series of logical operations controlling a computer to perform specific tasks or functions. An ASIC is an example of a processor for a special purpose computer, rather than a processor configured for general-purpose use. An application-specific integrated circuit generally is not reprogrammable to perform other functions and may be programmed once when it is manufactured.

In another example, a processor may be of the “field programmable” type. Such processors may be programmed multiple times “in the field” to perform various specialized or general functions after they are manufactured. A field-programmable processor may include a Field-Programmable Gate Array (FPGA) in an integrated circuit in the processor. FPGA may be programmed to perform a specific series of instructions which may be retained in nonvolatile memory cells in the FPGA. The FPGA may be configured by a customer or a designer using a hardware description language (HDL). In FPGA may be reprogrammed using another computer to reconfigure the FPGA to implement a new set of commands or operating instructions. Such an operation may be executed in any suitable means such as by a firmware upgrade to the processor circuitry.

Just as the concept of a computer is not limited to a single physical device in a single location, so also the concept of a “processor” is not limited to a single physical logic circuit or package of circuits but includes one or more such circuits or circuit packages possibly contained within or across multiple computers in numerous physical locations. In a virtual computing environment, an unknown number of physical processors may be actively processing data, the unknown number may automatically change over time as well.

The concept of a “processor” includes a device configured or programmed to make threshold comparisons, rules comparisons, calculations, or perform logical operations applying a rule to data Yielding a logical result (e.g., “true” or “false”). Processing activities may occur in multiple single processors on separate servers, on multiple processors in a single server with separate processors, or on multiple processors physically remote from one another in separate computing devices.

“Retain” generally refers to the act of keeping possession or use of something; the act of remembering by keeping in mind or memory, such as in the context of storing in a computer memory whether in volatile, nonvolatile, or other memory; or to hold one object secure or intact relative to another such as in the physical sense via a fastening member or material.

“Rule” generally refers to a conditional statement with at least two outcomes. A rule may be compared to available data which can yield a positive result (all aspects of the conditional statement of the rule are satisfied by the data), or a negative result (at least one aspect of the conditional statement of the rule is not satisfied by the data). One example of a rule is shown below as pseudo code of an “if/then/else” statement that may be coded in a programming language and executed by a processor in a computer:

```
if(clouds.areGrey( ) and
(clouds.numberOfClouds > 100)) then {
  prepare for rain;
} else {
  Prepare for sunshine;
}
```

“Sense Parameter” generally refers to a property of the environment detectable by a sensor. As used herein, a sense parameter can be synonymous with an operating condition, environmental factor, sensor parameter, or environmental condition. Sense parameters may include temperature, air pressure, speed, acceleration, the presence or intensity of sound or light or other electromagnetic phenomenon, the strength and/or orientation of a magnetic or electrical field, and the like.

“Sensor” generally refers to an object whose purpose is to detect a sense parameter such as events and/or changes in the environment, and then provide a corresponding output. Sensors include transducers that provide various types of output, such as electrical and/or optical signals. By way of non-limiting examples, the sensors can include cameras, pressure sensors, ultrasonic sensors, humidity sensors, gas sensors, motion sensors, acceleration sensors, displacement sensors, force sensors, optical sensors, and/or electromagnetic sensors. In some examples, the sensors include barcode readers, RFID readers, and/or vision systems.

“Transformer” or “Transformer Model” generally refers to an artificial intelligence or deep learning architecture that implements a parallel multi-head attention mechanism. Transformers may be applied to text or to classify image input.

Transformers generally include an initial step by which the input is apportioned or broken up into manageable pieces. For text, tokenizers may be applied to convert text into tokens. In the case of image or video input, image processing may be applied to convert an image to a collection or sequence of flattened image patches.

The transformer architecture optionally also includes a single embedding layer, which converts the portions and positions of the portions into vector representations, one or more transformer layers, which carry out repeated transformations on the vector representations, extracting more and more image context or linguistic information (and these generally consist of alternating attention and feedforward layers), and optionally, an unembedding layer, which converts the final vector representations back to a probability distribution over the different portions.

Text may be split into n-grams encoded as tokens and each token converted into a vector via a table lookup. At each layer, each token is then contextualized within the scope of the context window with other (unmasked) tokens via a parallel multi-head attention mechanism allowing the signal for key tokens to be amplified and less important tokens to be diminished.

“Vertically Oriented” generally refers to an orientation where a reference vector is substantially parallel to gravity, or where a plane substantially perpendicular or orthogonal to the reference vector is substantially perpendicular or orthogonal to gravity.

“Viewing Area”, “Field of View”, or “Field of Vision” is the extent of the observable world that is visible. In case of optical instruments, cameras, or sensors, it is defined by an angle of view.

“Wheelchair” generally refers to a chair that includes multiple earth engaging elements such as wheels, tracks, and the like for providing mobility. Some wheelchairs include electric motors or other prime movers for providing additional mobility.

1. A wheelchair, comprising:
a drive system operable to move the wheelchair;
a camera assembly that includes multiple cameras defining multiple corresponding fields of view, wherein at least two of the multiple corresponding fields of view include a portion of the wheelchair.
a control circuit responsive to image data from the multiple cameras, wherein the control circuit includes control logic configured to:
automatically analyze the image data received from the multiple cameras to determine areas to avoid based on the image data, and to determine a path for the wheelchair to pass through based on the image data;
determine control commands for the drive system that correspond to the path; and
activate the drive system according to the control commands to allow the wheelchair to move along the path.

2. The wheelchair of claim 1, wherein the control logic is configured to automatically calculate a series of control commands that will result in the wheelchair moving outside the areas to avoid.

3. The wheelchair of claim 1, wherein determining a path for the wheelchair to pass through includes calculating a series of control commands that will result in the wheelchair moving along the path.

4. The wheelchair of claim 3, wherein determining a path for the wheelchair occurs prior to activating the drive system.

5. The wheelchair of claim 1, wherein the control logic is configured to automatically determine speeds and trajectories for objects in the field of view of the cameras using the image data, and wherein the control logic is configured to generate updated control commands adjusting forward speed and turn rate of the wheelchair accordingly.

6. The wheelchair of claim 1, wherein the control logic includes a Convolutional Neural Network (CNN) configured to receive the image data as input and to detect objects based on the image data provided by the multiple cameras.

7. The wheelchair of claim 1, wherein the control logic includes a transformer model configured to receive the image data as input and to determine the path for the wheelchair.

8. The wheelchair of claim 1, wherein the control logic is configured to detect doorways and hallways captured in the image data and to add the doorways and hallways to the path.

9. The wheelchair of claim 1, wherein the control logic is configured to detect stairs and to add the stairs to the areas to avoid.

10. The wheelchair of claim 1, wherein the control logic is configured to detect bodies of water and to add the bodies of water to the areas to avoid.

11. The wheelchair of claim 1, wherein the control logic is configured to navigate the path without using location input from a location finding device.

12. The wheelchair of claim 1, wherein the control logic is configured to navigate the path without using a predetermined route calculated prior to activation of the drive system.

13. The wheelchair of claim 1, wherein the control logic is configured to detect traffic signals based on the image data, to determine the state of the traffic signals, and to modify the control commands accordingly.

14. The wheelchair of claim 1, wherein the control logic is configured to detect the relative distance of objects represented in the image data, and to modify the control commands accordingly.

15. The wheelchair of claim 1, wherein the multiple cameras include at least one forward facing camera defining a forward field of view that includes front portions of the wheelchair, and at least one downward facing camera defining a downward field-of-view that captures at least a portion of the wheelchair.

16. The wheelchair of claim 1, comprising:
an input device operable to accept control input for the wheelchair, wherein the control circuit is responsive to the input device, and wherein the control logic is configured to evaluate the control input along with the image data when determining the control commands for the drive system.

17. The wheelchair of claim 16, wherein the input device is coupled to the wheelchair, and wherein the control input is provided by an operator of the wheelchair.

18. The wheelchair of claim 17, wherein the operator of the wheelchair is remote from the wheelchair.

19. The wheelchair of claim 16, wherein the control logic is configured to determine in advance when the control input received from the input device will result in the wheelchair entering an area to avoid based on the image data, and to override the control input accordingly.

20. The wheelchair of claim 16, wherein the input device includes at least one of the multiple cameras, wherein the control input is received as part of the image data.

21. The wheelchair of claim 20, wherein the control input includes image data depicting a movement made by the operator or a nearby person expressing a command.

22. The wheelchair of claim 16, wherein the control input includes speed and directional input.

23. The wheelchair of claim 22, wherein the control logic is configured to determine a next left or right turn opportunity and to automatically turn upon receiving directional input from the operator.

24. The wheelchair of claim 22, wherein the control logic is configured to determine a next left or right turn opportunity and to automatically turn upon receiving directional input from a remote computing device.

25. The wheelchair of claim 16, wherein the control input is received from an operator of the wheelchair, and wherein the control logic is configured to evaluate the control input and to pass the input directly to the drive system unless the control logic determines that operating the wheelchair according to the control input would result in the wheelchair entering an area to avoid.

26. The wheelchair of claim 1, wherein the control circuit is configured to transmit image data obtained from the multiple cameras to a remote computing device.
